(19) United States
(12) Patent Application Publication
(10) Pub. No.: US 2008/0219652 A1
(43) Pub. Date: Sep. 11, 2008

(54) SYSTEM, METHOD AND APPARATUS FOR ILLUMINATION AND PHOTOGRAPHIC CAPTURE OF A SUBJECT

(76) Inventors: Stephen Pitkin, Rockford, IL (US); Dale Thorstens, Rockford, IL (US); Donn Woodworth, Rockford, IL (US); Karla Woodworth, Rockford, IL (US); Donn Woodworth, Rockford, IL (US); Elizabeth Tymonko (Woodworth), Lawrenceville, NJ (US)

Correspondence Address: KEITH FRANTZ, 401 WEST STATE STREET, SUITE 200, ROCKFORD, IL, 61101, US

(21) Appl. No.: 11/938,759

(22) Filed: Nov. 12, 2007

Related U.S. Application Data
(60) Provisional application No. 60/865,191, filed on Nov. 10, 2006.

(51) Int. Cl. G03B 15/03; G03B 15/02

(52) U.S. Cl. 396/4; 396/155

(57) ABSTRACT

A system and apparatus for illumination and photographic capture of a subject includes a base, a linear drive unit carried on the base, a light bar configured to produce a band of illumination and connected to the drive unit, and system controls operatively connected to the drive unit and light bar to achieve controlled linear movement of the light bar and progressive illumination of the subject with the band of light. A method for illumination and photographic capture of the subject includes establishing a band of light projecting across one direction of the subject, powering the band of light at a controlled speed through a second direction to progressively illuminate the subject; and making a photographic exposure of the subject with a camera while progressively illuminating the subject with said band of light.

### CROSS-REFERENCES TO RELATED APPLICATIONS

This application claims priority to U.S. Provisional Patent Application Ser. No. 60/865,191 filed Nov. 10, 2006.

### INCORPORATION-BY-REFERENCE OF MATERIAL SUBMITTED ON A COMPACT DISC

Not Applicable.

### STATEMENT REGARDING FEDERALLY SPONSORED RESEARCH OR DEVELOPMENT

Not Applicable.

### BACKGROUND OF THE INVENTION

1. Field of Invention

The present invention relates to illumination systems, methods and apparatus for use in the field of photography.

More particularly, the invention relates to a system, method and apparatus for illuminating a photographic subject, and which, while capable of use with a moving subject, is particularly suitable for use in achieving consistent, controlled illumination of a stationary or still subject to obtain a high-quality, precision photographic capture of the subject, and is further adaptable for use in photographing subjects ranging in size from relatively small to very large, including, but not limited to, wall-mounted subjects, floor-laid subjects, three-dimensional subjects and free-standing subjects in a studio environment as well as in the subject's natural environment.

2. Background Art

One of the more difficult problems in photographing an object is consistent control of the light source used to illuminate the object. Particular difficulty arises while attempting to uniformly illuminate large subject matter. Commercially available photographic lighting offers sufficient output for general photographic use, but such lighting must be typically positioned at a great distance from the subject in attempting to evenly distribute light on the subject while taking the photograph. As the light source is moved further from the subject, it's illumination becomes more evenly distributed across the surface of the subject, but in so doing, the efficiency of the light source decreases. In other words, the farther the light source is from the subject, the less illumination the light source projects onto the subject. Multiple light sources are then required to achieve sufficient output levels for proper illumination of the subject. While multiple light sources can combine to provide a desired light output, multiple light sources are not capable of providing truly uniform lighting, color, illumination, and angle of incidence. Each light source projects light from a unique perspective, and combines with the other light sources to produce multiple highlights and multiple shadows on the subject. This effect diminishes a perception of structural depth in an object being photographed. Thus, although photographers desire the benefits of a single light source, they are reluctantly required to use multiple light sources in order to achieve necessary levels of illumination.

Established methods for photographing objects require great quantities of lighting equipment and technically skilled operators to obtain relatively even illumination of the object. Consistently illuminating a large area is complicated by the requirement of multiple light source, and determining the best locations for the light sources. As noted above, multiple lights are necessary to achieve sufficient exposure value. However, individual lights also have a variety of color temperatures and intensity of output. Therefore, multiple light sources cannot accurately work together to produce even illumination or color across a large field of view. Depth of surface structure is not optimally captured when multiple light sources are used at various angles of projection. Traditional attempts to overcome these problems include mass diffusion of the light sources in order to mask their directional nature and other inconsistencies such as color and brightness. Diffusion of the light source, however, dramatically reduces the efficiency of light output, diminishes visible surface texture and color saturation, and increases surface glare.

Smaller, relatively flat objects can currently be photographed, or reproduced on a conventional scanner or a reprographic stand. The conventional scanner, with a scanner head under a glass sheet, is limited to effective use with flat objects. Reprographic stands provide additional flexibility over a conventional scanner, but are still limited to use with smaller objects.

A typical reprographic stand includes a table top onto which the subject is positioned, and either an overhead light that scans across the subject for illumination and photographic capture with an associated camera, or an overhead scanner head for illumination and digital capture. In either event, the thickness of the subject is limited, at least, by the distance between table top and the overhead light or scanner. Consequently, conventional reprographic stands are limited in their use, and are simply not suitable for use in photographing very large objects, wall-mounted objects, or three-dimension free-standing objects.

### SUMMARY AND DISCLOSURE OF THE INVENTION

The general aim of the present invention is to provide a new and unique photographic illumination system, method and apparatus that reduces or eliminates the above-described disadvantages and drawbacks of conventional equipment and methods for illuminating a photographic subject.

An objective of the invention is to provide a system, method and apparatus capable of uniformly projecting light onto a photographic subject, in a manner that enables photographic capture of the subject with superior photographic qualities as compared to results achievable with previous photographic illumination devices and techniques.

Another objective of the invention is to provide a photographic illumination system, method and apparatus capable of simultaneously enhancing surface texture, tonal range, and color saturation of the subject as compared with photographic capture quality capability achievable with prior photographic illumination devices and techniques.

Another objective of the invention is to provide a system, method and apparatus for illuminating a photographic subject that reduces the equipment required to photograph certain subjects, and particularly larger subjects which conventionally require multiple light sources and related apparatus in an effort to achieve uniform lighting.

Another objective of the invention is to provide a system, method and apparatus for illuminating a photographic subject that reduces the technical experience, skill and “art” conventionally required to achieve good, consistent photographic results, particularly when photographing large or surface-challenging objects.

Another objective of the invention is to provide a system, method and apparatus for illuminating large photographic subjects and subjects in their natural or normal environment, such as wall-mounted subjects, floor-laid subjects, and free-standing subjects.

Another objective of the invention is to provide a system, method and apparatus suitable for illuminating large photographic subjects and capable of implementation in a portable system that is foldable, collapsible or otherwise configured to be easily assembled on site by one or two people with few or no tools, and is easily disassembled for transportation and storage.

Another objective of the invention is to provide an illumination system, method and apparatus that is uniquely flexible and adaptable for use in photographing a wide variety of subjects, of different orientations and in various environments.

Another objective of the invention is to provide a system, method and apparatus for precision, automated, yet highly adjustable illumination of a photographic subject.

Another objective of the invention is to provide an illumination system, method and apparatus synchronized for operation with a digital camera.

Another objective of the invention is to provide an illumination system, method and apparatus that reduces the studio space or environmental work space required for photographing certain subjects, particularly larger subjects, as compared with the space required when using conventional equipment and techniques for illuminating the same subject.

Another objective of the invention is to provide an illumination system, method and apparatus capable of reducing surface glare on the subject.

These and other objectives and advantages of the invention will become more apparent from the following detailed description when taken in conjunction with the accompanying drawings.

The goals and objectives of the invention are achieved in a system, method and apparatus that includes moving a band of illumination across a stationary camera's field of view (the “picture plane”) of a subject during a photographic exposure of the subject. A light source produces a band of light that projects along one direction (e.g., height, width, or length) across the subject to be photographed, and is drawn (driven or otherwise powered) along a second direction across the subject for progressive linear illumination of the subject. Movement of the light source is controlled by operator initiated and/or automated controls (e.g., via electronic, digital, software, etc. means) such that the subject is automatically, progressively illuminated with a predictable intensity band of illumination during the photographic exposure. The controls effect movement of the light source at a predetermined speed across the subject, to obtain desired illumination of the subject. Typically, the light source is controlled to a constant, selectable speed for even, maximum intensity illumination of the subject. Alternately, the controls can be provided (e.g., programmable) for varied or variable speed control, responsive to operator or other input criteria, to obtain alternate desired illumination of the subject. Control of the travel time (speed) of the light band illumination relates directly to the desired exposure value (i.e., capture media sensitivity) after establishing the illumination and lens aperture setting of the camera. Slower travel times offer a greater accumulation of light, enhancing image quality and depth of field. Faster travel times offer benefits of shorter required exposure times. These predictable, repeatable photographic-session characteristics obtainable with the invention, and others characteristics described herein, result in unique ease of consistent quality photographic capture of many varied subjects, and reduces the conventional photographic technical experience, training, skill and “art” required to obtain quality photographs (i.e., photographic capture).

An illumination system and apparatus in accordance with the invention is provided with a base or frame, a linear drive unit carried on the base, a light bar (i.e., a source of linear band of illumination) connected to the drive unit, and system controls operatively connected to the drive unit and light bar for control thereof. The base is configured to provide stable support for the particular embodiment illumination system. The base of a floor or table-top system is configured to rest on and establish stable support from the floor or table top, or other horizontal surface. The base may be alternately configured to establish support from a vertical, inclined or irregular structure or surface. Specific base configurations will be implemented by those skilled in the art for cooperation and use with a surface or structure with which it is intended to interface and from which such support is to be established, with consideration of the linear drive unit and light bar configuration and operation on the particular system being accounted for, and other aspects of the invention as described herein. For example, but without limiting the foregoing, the base may comprise a clamp arrangement for securing to the edge of a table top, a wall structure or a ledge, suction cups for smaller systems, or a fastener arrangement for securing to an appropriately configured support structure. The drive unit effects powered linear movement of the light bar responsive to the system controls, and is located, during use, outside (above, below, and/or to the side of) the camera's view of the subject to be photographed. The light bar produces the band of light for projection along one axis or direction of the subject, and scanning along a second (e.g., perpendicular) axis or across the other direction of the camera's view of the subject. The system controls receive input instructions from the operator, and/or an input (e.g. automated) device, as to the desired illumination parameters (e.g., light bar speed, light intensity, etc.) for the photographic session, and controls the operation of the drive unit and scanning illumination of the light bar across the subject responsive to such instructions. The system controls can be coupled with the electronic, digital and/or software driver controls for a digital camera, for integration of the illumination system with the digital camera system.

To photograph a subject, the illumination device is positioned with the light bar between a camera and the subject. Initially, the light bar illuminates a band along one entire dimension of the subject. Upon initiation, either directly or indirectly, by an operator and/or such as through the camera controls, the system controls cause the linear drive unit to draw the light bar along the perpendicular or other direction of the subject at a controlled speed according to input instructions such that the entire subject is progressively illuminated by the band of light. Typically, the device will be positioned and controlled for movement of the light bar at a constant speed through a plane that is generally parallel to the surface of the subject to be photographed (the picture plane). This results in a controlled, consistent, maximum intensity light band bathing the subject in a linearly progressive manner. All parts of the illumination system and apparatus exposed in the field of view of the camera, and particularly all parts of the moving light bar located in the camera's field of view of the subject, are provided with a non-reflective surface. Consequently, the presence of the illumination system and apparatus, although in the field of view of the camera, and the presence of the light bar, although located directly between the camera and the subject, are not recorded in the fully exposed photographic capture of the subject. Thus, the illumination system and apparatus is “invisible” to the camera, and the camera progressively records the maximum (typically constant) exposure of the subject in the photographic medium as the light progressively illuminates the subject.

To photograph a subject with a horizontal orientation (i.e., to photograph a generally horizontal surface of a subject), such as an object laid onto a floor or table top, the light bar is mounted for linear movement through a horizontal plane established at a substantially constant distance from the subject. The light bar may be oriented to illuminate with a band of light across, for example, the width of the horizontal subject, and then scan along the length of the subject. To photograph a subject of vertical orientation, such as a wall-mounted subject or the front of a free-standing object, the light bar is mounted for linear movement through a vertical plane. The light bar may illuminate with a band of light across, for example, the width of the vertical subject, and then scan along the height of the subject. Similarly, to illuminate a subject oriented along an alternate plane, the light bar is mounted for linear movement through a plane generally parallel to the plane of the subject.

As used herein, except as noted otherwise: the term “camera” includes a conventional film media camera, a single-capture digital camera, a multi-capture digital camera, a digital scanning camera, and similar digital imaging and digital image capture devices, and imaging software; the phrase “photographic capture” includes image capture on conventional film media as well as optical, electronic, and other analog and digital capture medium and storage thereof, and “light bar” includes a source capable of generating a linear band of illumination in a spectrum suitable for photographic capture of a subject with a camera.

The linear illumination of the light bar is produced with a linear light source or light array housed in a shroud/reflector that generally surrounds the light source, but that has an open front through which light passes for projection onto the subject. With the light bar positioned to illuminate the subject as it traverses a plane generally parallel to the subject, the shroud/reflector is positioned with its open front angled towards the subject for angular projection of the light onto the subject. This angular projection enables illumination of the subject with the light bar located between the subject and the camera. The proximity of the illumination to the subject, combined with the angular projection, enables capture of enhanced surface texture and tonal range of the subject during photographic exposure as compared with conventional methods of photographic illumination involving multiple point light sources to the side and/or behind the camera and at a greater distance from the subject.

In general, the open front of the shroud/reflector is set to project light at between approximately thirty (30) degrees to sixty (60) degrees offset from the line of sight between the camera and the subject (e.g., 30-60 degrees from perpendicular to the direction of travel of the light bar when setup for movement in a plane parallel to surface of the subject). Setting the projection of light to greater than approximately 60 degrees, while still providing some illumination of the subject, results in increasing loss of maximum illumination of the subject. In other words, increasing the angle of projection widens the band of illumination on the subject, and decreases the efficiency of the light source in relation to the illumination projected onto the subject. As a result, increased angles of projection would require a higher intensity light source to develop the same illumination on the subject as a less intense light source set at a more direct angle toward the subject. On the other hand, setting the projection of the light at less than approximately 30 degrees will result in an increased percentage of the illumination band that does project onto the subject being blocked by the back side of the light bar (i.e., less of the light band that does illuminate the subject being seen by the camera), or a narrowing of the actual photographic exposure light band on the subject. The effect of this parameter will depend on the blocking width of the particular light bar in relation the camera position and the size of the subject. The more light that is blocked on a continuous basis results in less band width available for the maximum intensity photographic capture, and correspondingly slower travel times, larger aperture settings, and/or photographic times and other photographic problems. Under most photographic conditions encountered during development of a prototype unit (discussed further below), it was found that an angular projection of approximately forty-five (45) degrees, for projection of light generally upwardly or downwardly at an angle of approximately forty-five (45) degrees onto the subject, is generally preferred as providing a good compromise between these two competing concerns. Further, it has been found that 45 degree angular projection of illumination enhances the three-dimensional depth perception captured in a photograph due to development of very soft shadows when photographing objects with non-uniform surfaces. One preferred light source is specified as for production of low levels of heat, IR, and UV radiation. The color temperature range of the light source is comparable to daylight (approximately 5,5000 Kelvin). This further enhances the quality capability of the photographic exposure as compared with use of conventional point light sources. In preferred embodiments, to photograph a vertical subject with a single illumination source, the illumination will project angled downwardly onto the subject to obtain the most “realistic” look in the photograph.

The ends of the shroud/reflector are preferably closed to prevent loss of useable illumination and reduction or drop-off of light intensity near the ends of the shroud. This results in constant linear illumination along the entire length of the open front of the shroud/reflector, and minimizes the length of the shroud/reflector in relation to its operative length as established by the length of the band of constant illumination. Alternately, for example, where reduction of light intensity is not of concern e.g., the light bar is much longer than the same dimension of the subject), or where a decreasing intensity may be desired such as for photographic expression, the ends of the shroud/reflector may be left partially or fully open, and may be provided with, for example, variable-position plates for operator adjustability of the loss of illumination therefrom and the corresponding reduction of illumination on the applicable areas of the subject. To further enhance illumination efficiency of the light bar, the inside surfaces of the shroud/reflector are provided with a highly reflective finish. When combined with the closed ends, this results in reflection of virtually all illumination produced by the light source exiting through the open front of the shroud.

Polarizing filters may be applied to either the light source or the camera, or both, simultaneously. A polarizing film, or rigid polarizing cover over the open front of the shroud/reflector reduces surface glare developed on the subject matter, a polarizing filter on the camera filters surface glare from the subject, and use of both filters virtually eliminates photographic capture of any reflections from the subject. The benefit of double polarization includes an improved sense of surface texture and color saturation, as well as consistency in illumination over large areas, and predictable exposures. Consistent performance with double polarization eliminates or substantially reduces the need for repeated testing or acquiring multiple exposures in trial and error when photographing subjects with double polarization. The quality of light and photographic exposure is unobtainable with conventional photographic lighting equipment and techniques. Use of polarizing filters on point light sources is not suitable because of the greater distance of the conventional light source from the subject. Whereas, despite polarization of both the light source and the camera, the exposure time utilizing the invention can be run at relatively high speeds and small apertures by virtue of the proximity of the light source to the subject. A layer of diffusion material may be secured to the polarizing film (between the light source and the polarizing filter) for further photographic expression purposes without adversely affecting the above-mention advantages with use of the polarizing film. —Polarizing filters may be applied such that double polarization is adjustable to the photographer's discretion. Polarization filters control glare. These filters can be adjusted by the photographer, to establish the amount of glare (may desire for some shiny surfaces), and may involve use of graduating or adjustable polarization filters.

In preferred embodiments, an illumination system and apparatus in accordance with the invention is free-standing for illuminating a photographic subject. The free-standing illumination system and apparatus is characterized by the absence of the need for a platform or other structure to carry or support the subject as compared, in contrast with prior scanning devices and photographic reproduction devices. This unique characteristic results from, among other things, providing a structure, including the base (or frame) and linear drive unit located generally to the side, above, below and/or behind the light source, and in particular, not located in the operative planar range of illumination of the light source. This unique, non-restrictive structure permits the light bar to illuminate subjects in, for example, their natural setting, and is particularly advantageous for use in photographing wall-mounted subjects, floor-laid subjects (e.g., rugs), larger subjects and three-dimensional subjects. Although certain implementations of the invention may be supported near or from a table, used with a table, used in photographing a subject on a table, or even incorporate an optional (e.g., removable) table, preferred embodiments of the invention are implemented as free-standing, without the need for a table or other incorporated subject-supporting structure. In carrying out this aspect of the invention, the base supports the linear drive in a position for movement of the light bar in a plane corresponding to the plane of the subject to be photographed, with a generally planar (but having some depth) region of illumination associated therewith as the light bar travels through said plane, and without system structure or components in or forwardly (with respect to the direction of illumination projection) of said generally planar region of illumination.

In one free-standing embodiment, the base supports the linear drive unit and light bar system from a horizontal surface such as a floor or table top, the linear drive unit extends vertically from the base, and the light bar is connected to the drive unit for movement through a vertical plane. This configuration permits the system to illuminate a generally vertical subject, such as a wall-mounted subject or a free-standing subject. As shown in the three embodiments in the drawings, the free-standing aspects of the invention are easily implemented with either side to side (third embodiment), or up and down (first and second embodiments) movement of the light bar. In the first and second embodiments shown in the drawings, the linear drive unit and light bar are further configured for re-positioning and movement of the light bar through a horizontal plane, with the light bar illuminating downwardly onto the surface on which the base rests (or alternately upwardly away from the supporting surface). There is no system or apparatus structure or components between the range of illumination of the light bar and the system-supporting floor. By positioning the camera above the light bar, the system is capable of illuminating a photographic subject laid out on the floor. The linear drive unit and light bar of the first two embodiments shown are further configured for re-positioning and movement to selected angles between horizontal and vertical. Again, the absence of system and apparatus structure and components within the inclined operating range of illumination of the light bar enables illuminating and photographing a subject that may present an inclined side, or, for example, for individual photographic expression of an otherwise oriented subject.

An illumination system and apparatus in accordance with the invention may also be provided in a portable arrangement. Effective illumination of large subjects in accordance with the invention requires a corresponding large illumination device. In preferred embodiments particularly adapted for illumination of larger subjects and free-standing subjects, the system and apparatus is provided as foldable, collapsible and/or otherwise configured for ease of assembly on site such as by one or two people with few or no tools, and ease of disassembly for transportation and storage. In carrying out this aspect of such preferred embodiments, the base, the linear drive unit and the light bar are provided as substantially self-contained sub-units or assemblies that foldably, collapsibly, releasably or otherwise cooperate to establish a portable system.

In one collapsible, folding embodiment, the base extends generally in a first direction or plane, and the linear drive unit extends from the base for movement of the light bar in a second direction or plane, but is pivotally mounted to the base for swinging of the drive unit and light bar from their operative positions (in said second direction or plane) to extending generally parallel to the base. For example, in the first and second embodiments shown in the drawings, the base is horizontal, for supporting the system from a horizontal surface, and the linear drive extends vertically from the base for movement of the light bar through a vertical plane. The linear drive unit is pivotally mounted to the base for swinging of the drive unit and light bar, together, from their operative vertical position to a horizontal folded or stowed position more convenient for transportation and storage, with pins provided to lock the drive unit and light bar in both positions. Alternately, and/or in addition, the illumination system can be otherwise configured for quick disassembly and assembly, such as with the linear drive unit releasably connected to the base, and the light bar optionally releasably connected to the drive unit with threaded fasteners, pins, and/or other quick-release arrangements.

The specific configuration, location and orientation of the linear drive unit will be subject to implementation factors of the particular system, including, but not limited to, the orientation of the light bar and its direction of travel and intended region of illumination, as well as space available for the system and the arrangement of the linear drive unit selected for use. Typically, the linear drive unit will comprise one or more drive elements that extend a substantial distance in (or parallel to) the direction of powered linear motion of the light bar, and are located outside the camera's field of view of the subject. For a light bar to be moved up and down through a vertical plane, the linear drive element(s) will extend vertically, and, although the drive element(s) may be located above or below the light bar, to provide a compact system, will typically be located to one or both sides of the light bar. For a light bar to be moved side to side in a vertical plane, the linear drive element(s) will typically extend horizontally and located above and/or below the light bar. Similarly, for a horizontally moving light bar, the drive element(s) will typically extend horizontally, and located to the front, back and/or at the side(s) of the light bar. And for a light bar that translates in a plane inclined between horizontal and vertical, the drive element(s) will be oriented in the same or a parallel inclined plane outside the camera's field of view of the subject.

The connection between the linear drive unit and the light bar will also be subject to implementation factors of the particular system. In a precision illumination system with, for example, a large horizontal light bar that would be subject to cantilever effects of gravity, a preferred linear drive unit will include two parallel, precision linear drive elements that are spaced apart for connection to each end of the light bar, and are secured to a support structure that establishes precise dimensional stability between the ends of the light bar. This enables provision of an extremely stiff system in which the angular positioning of the light bar (in relation to the drive elements and supporting framework) can be maintained essentially fixed, counteracting the potential bending effect of gravity on the large light bar, and, therefore, the light bar will be less likely to twist or wobble such as in embodiment with a single-point connection to the large light bar, as the light bar is powered through the plane of illumination.

The configuration of the linear drive elements will also be subject to implementation factors of the particular system. As the skilled artisans will recognize, available linear drive elements will be generally adaptable for use in an illumination system according to the invention. By way of non-limiting examples, adaptable linear drive elements will include pulley and belt drives, cable drives, gear drives, gear and chain drives, and rack and pinion drives. In a precision illumination system, low-friction drive elements, such as ball screw and nut driven linear slides (shown in the three embodiments in the drawings), are generally preferred for mechanical operating advantages (as compared with higher friction elements) including lower power drive requirements and reduced friction related errors in operation and control of the system. Linear slide assemblies may move on, for example, ball linear/round way assemblies, ball linear/profiled rail assemblies, ball roller/track assemblies, or other linear motion arrangements available to the designer, designated based on design criteria such as friction, overturning moment loads, speeds, or space constraints. Linear slide assemblies may also be moved by, for example, rolled ball screws and ball nuts, precision ground ball screws and ball nuts, planetary roller screws and nuts, roller chain, timing chain, cable chain, gear belts, or timing belts, and other available linear drive arrangements.

In the first (and second) embodiment shown in the drawings, the linear drive unit comprises a pair of elevator elements with ball screw and nut driven, low-friction linear motion slide assemblies mounted to base tubes. The tubes are secured to support braces located at opposite ends of the light bar, at opposite sides of the base, with a slide assembly connected to each end of the light bar. Simultaneous rotation of the ball screws causes the slide assemblies to move longitudinally along the length of the ball screws, and the light bar to translate therewith. The screw drive linear motion slides offer advantages, in addition to low friction and high precision, over other drive methods, including considerations regarding safety, motion flexibility, motion smoothness and mechanical advantage. For example (such as in the first and second embodiments shown), when the elevators are vertical, with the screw and nut drive elements, almost any failure in the drive line is non-catastrophic. In other words, failure of the drive line will simply result in non-movement of the light bar. Whereas with a gearbelt, chain or certain other drive elements, drive line failures may allow the light bar to fall, potentially resulting in equipment damage and injury to the operator.

As previously noted, the system and apparatus controls receive instructional information from the operator as to desired illumination parameters for the photographic session, and effect operation (e.g., start, stop, speed, position, acceleration, illumination intensity, etc.) of the linear drive unit and light bar, and the resulting scanning illumination of the subject according to the parameters set by the operator for the session. Accordingly, the system and apparatus controls comprise applicable input, processing, and output control modules according to implementation factors of the system. Such factors will include, but are not limited to, power requirements, error sources, and other consideration of the linear drive unit, whether the control system is to operate open-loop or closed-loop, system failure mode considerations, and the extent to which the operator is allowed to manually adjust or control such operations. The system controls may also be configured to operably communicate and integrate with the software driver controls and/or other controls of a digital camera of any available type.

In a manual embodiment, an input unit (or input module) is provided with a “start” button (switch, etc.) that will turn the light source on (if not already on), and initiate operation of the linear drive unit to cause the light bar to traverse through the plane of illumination at a pre-established constant speed. Movement of the light bar may either be activated with, for example, the same button from this position for the next photograph, or returned to its initial position either automatically (upon completion of the illumination cycle) or upon the operator pressing a second “return” button (or toggle a switch to a second “return” position, etc.) prior to initiation of the illumination cycle for the next photograph. In these instances, the signal from the input module will be appropriately conditioned and/or time controlled as required for the system, and then fed to the light bar and linear drive unit for directed operation thereof. Position switches or other considerations (e.g., timing of movement, etc.) will provide shut-down signals as the light bar approaches each end of its linear motion. An alternate input module will allow the operator to manually select the speed of the light bar from, for example, a choice of pre-set speeds such as with a selector knob with pre-established positions, a variable range with a variable speed selector input device. For maximum flexibility, such as to account for unique subjects or enable further photographic expression, the system controls are configured so that the operator can establish, for example, and in addition to a predetermined or an adjustably constant speed profile, a variable speed profile over the range of travel of the light bar, as well as permit adjustment of other illumination parameters such as the frequency, wave-length, intensity, color and/or temperature range of the illumination in both the visible and non-visible ranges. In such embodiments, the input module controls are adjustable or programmable for operator selection or specification based on, for example, surface parameters of the subject, photographic exposure, operating characteristics, and individual expression. These, and other input modules may be located on the base or framework of the illuminating device or an convenient in the particular implementation of the invention, but are preferably locatable remote from the illuminating device while being operably connected thereto for activation of the drive unit and light bar by the operator such as at the location of the camera. In general, the system and apparatus controls will provide for analog input, digital input, or both, by the operator, as well as optional controls to enable manual selection of light bar movement speed, starting, stopping, dwell, etc. Suitable system and apparatus controls will be readily devised by those skilled in the art for cooperation with the system and apparatus characteristics desired. The controls may also be configured to integrate with the software or other drivers of a digital camera of any type, or a film media camera, as well as other graphic imaging software as desired for a particular implementation of the invention, including, for example, servo control of camera position during the photographic exposure.

In precision embodiments, the system and apparatus controls will preferably comprise automated electronic digital controls with a signal processing module and a feedback element for closed-loop control of movement of the light bar. The feedback element is connected to detect and provide a signal indicative of the position and/or speed of the linear drive unit, and thus indicative of the position and/or speed of the light bar, to the signal processing module. Using a closed-loop algorithm, the processing module compares the indicated position and/or speed of the light bar with a reference signal indicative of the operator input, and adjusts the position and/or speed to reduce the error therebetween and achieve accurate operation of the drive unit. The automated digital controls of this arrangement will be configured for cooperation with the software or other drivers of a digital camera, as well as other graphic imaging software, as applicable for the particular implementation of the invention.

In the first and second embodiments shown in the drawings, the linear drive elements include linear motion ball screw and nut driven slide assemblies as described above. The slide assemblies are driven by dedicated rotary power drivers in the form of servo-motors coupled to the ball screws. Rotation of the servo-motors and ball screws cause the linear slide assemblies to translate along the length of the ball screws. Rotary sensors such as resolvers are coupled for rotation predictably related to rotation of each of the servo-motors to sense and provide a feedback signal indicative of the angular position and/or rotation thereof. This feedback is provided to a digital processing module which, with suitable algorithms, tracks the angular position and/or speed of the motors, the number of turns of the motors from a reference position, the precise linear position of the slide assembly on each side of the light bar, and/or other operational characteristics of the motors and slide assemblies for individual comparisons to the reference signal(s) resulting from the operator input. The servo-motors are individually controlled from these individual comparisons to obtain identical, synchronized linear movement of the two sides of the light bar. Alternate rotary or linear feedback elements may be designated in alternate embodiments to effect closed-loop control of the light bar.

From the foregoing, and in further consideration of the embodiments shown in the drawings and discussed in detail herein, it will be clear that the system, method and apparatus of the present invention uniformly projects a linear light source onto a photographic subject, in a manner capable of enhancing and optimizing consistent light balance, surface texture and tonal range, and thereby enabling a superior photographic capture of the subject as compared to photographic capture capabilities utilizing prior techniques and equipment. The invention also provides an automation capability of the photographic process, reducing the need for highly skilled technicians. An evenly distributed, smooth quality of light, capable of integrating with film, digital cameras and non-traditional imaging media, is unobtainable with any prior lighting system or technique. Predictable exposures and color temperatures available with the present invention virtually eliminate the need for trial and error test exposures while preparing a photographic subject. The linear illumination and its relative close proximity to the subject provides a dramatic increase in light efficiency. The angle of illumination in relation to the plane of linear movement provides an improved sense of surface texture and reduction in surface glare. Due to superior light efficiency, additional filtration (polarizing filters) can be used to improve image quality at both the light source and the camera, while maintaining relatively high speed exposure times and small apertures settings, which cooperate to improve image quality.

As those skilled in the art will appreciate, the illumination system, method and apparatus in accordance with the invention can be implemented with, for example, a lower cost drive in an open-loop arrangement, or where movement of the light source is accurately calibrated and controlled such as with precision linear motion elements, feedback elements, and digitally controlled power drivers optionally integrated with digital camera software drivers. In either event, an important advantage of the invention is the capability of provision of consistent illumination of a photographic subject previously unattainable with traditional photographic techniques or equipment, and an enhanced sense of surface texture in the photographic exposure.

The illumination system, method and apparatus in accordance with the invention is also extremely flexible and adaptable for implementation in alternate embodiments to achieve additional advantages and capabilities, and for illuminating a wide variety of photographic subjects of different orientations and in various environments. For example, the light shroud/reflector can be either connected in a fixed position in relation to the drive unit, or pivotally mounted for angular positioning as desired for a particular subject, expression or other parameters of the photographic session. Selective angular positioning of the shroud/reflector can be provided through either manual rotation, or powered rotation such as with a small motor and signal from the system controls initiated from, for example, specific operator instructions, or automatically according to pre-programmed instructions responsive to the subject, expression and/or other parameters of the photographic session input to the controls. A manual locking and release device will typically be provided for the manually rotatable shroud/reflector configuration, for adjusting and then fixing the direction of illumination projected from the light bar, and can be optionally provided for the power-rotated shroud/reflector configuration.

It will also be understood that an illumination system, method and apparatus in accordance with the invention is not limited to use in photographing substantially flat subjects, or three-dimensional subjects having a generally planar side. Implementation of the invention is capable of illuminating subjects with sides having substantial depth variations and/or curvatures. In a particularly customized embodiment, a curved light bar may be provided for illumination of a corresponding curved subject. Drawing the curved light bar along the direction perpendicular to the curvature of the subject (e.g., as scanning longitudinally along the side of a large cylindrical object) results in the substantially constant illumination of such subjects. Other implementations may be provided with alternate curvatures or shapes for desired illumination purposes. It will be further understood that the suggested relationship of a substantially constant distance between the light bar and the subject to be photographed are guidelines suitable for most conventional photographic sessions. Whereas, the individual photographer will appreciate that alternate spatial relationships may be used advantageously to achieve individual and unique photographic expression, including, but not limited to non-constant distance (in relation to the subject) from one end of the light bar to the other, and non-constant distance as the light bar travels from one end of the subject to the other. Thus, in addition to the unique advantages the present invention brings to promote ease of consistent production of photographs, and in view of the additional aspects of the invention discussed herein, it will be clear that the invention provides the photographer with expressive tools and techniques heretofore unavailable.

An illumination system, method and apparatus according to the invention will find advantageous use through the entire range of photography, including studio and documentary photographers. The system, method and apparatus hereof are compatible with conventional and current state of photographic industry cameras, including conventional film media cameras, and digital cameras of all types including single capture, multi-capture and scanning digital cameras. The system, method and apparatus of the invention will benefit the novice photographer to the most seasoned professional. Self-contained lighting according to the invention provides a light quality superior to any other available product or technique, and it offers a level of automation capable of providing flawless results regardless of the operator. The system and apparatus of the invention can be designed to be portable and assembled on site by one or two persons with few or no tools. The system and apparatus of the invention can be carried to, and the method practiced at, an excavation site. Fossils and artifacts can be more precisely photographed as they are uncovered, without the need to remove the subject for precision photographing at an off-site location. And the system and apparatus of the invention can be transported to and setup, and the method practiced, in a museum. The artwork, whether it be wall-mounted or three-dimensional work, can be precisely photographed in the museum environment, without the need to package and transport the work to an off-site photographic specialist.

### BRIEF DESCRIPTION OF THE DRAWINGS

FIG. 1 is a rear perspective view of a single linear array illumination system incorporating the unique aspects of the present invention, the illumination system comprising a base and an elevator or linear drive unit shown in a vertical position for moving a linear array light bar vertically, to progressively illuminate a wall-mounted subject for photographic capture of the subject by a camera.

FIG. 1A is an enlarged fragmentary perspective view of the right pivot connection between the elevator unit and base as shown in FIG. 1.

FIG. 2 is a right side view of the illumination system, camera and subject shown in FIG. 1.

FIG. 2A is an enlarged fragmentary view of the light bar and a slide assembly of the elevator unit shown in FIG. 2, with one end of shroud/reflector of the light bar removed for viewing certain internal components.

FIG. 3 is a front perspective view of the illumination system and camera shown in FIG. 1.

FIG. 3A is an enlarged fragmentary view of the light bar and right slide assembly as shown in FIG. 3.

FIG. 3B is an inverted perspective view of the light bar shown in FIGS. 1-3.

FIG. 4 is an alternate front perspective view of the illumination system, showing an upper position of the linearly movable light bar in dashed lines, and a lower position of the light bar as controlled by the linear drive unit and controls for illuminating a subject for photographic capture.

FIG. 5 is a front perspective view of the illumination system, representing with dashed lines alternate selectable angular positions of the linear drive unit between vertical and horizontal, for use in illuminating alternately oriented subjects.

FIG. 6 is a front perspective view of the illumination system with the linear drive unit secured into one of its alternate angular positions, and the light bar rotated to face rearwardly and downwardly, to illuminate an inclined subject behind the unit.

FIG. 7 is a front perspective view the illumination system, with the linear drive unit secured into its horizontal position, and the light bar rotated to face generally downwardly, to illuminate a horizontal subject below the unit, such as laid out on a floor or table top on which the system is supported.

FIG. 8 is an enlarged fragmentary perspective view of the linear drive unit in its horizontal position and the light bar, shown removed from the base of the system for viewing certain components thereof.

FIG. 9 is an enlarged side view of the light bar shown removed from the system, with one end of the shroud/reflector shown removed for viewing certain internal components of the light bar.

FIG. 10 is an enlarged fragmentary perspective view of the linear drive unit in its horizontal position as shown in FIG. 7, a slide assembly, and connection to the light bar, but with the light bar inverted or rotated up from what would be its normal operating position as shown in FIG. 6 with the elevator unit horizontal as shown to expose for viewing certain details of the light bar.

FIG. 10A is a view similar to FIG. 10 showing the linear drive unit in its vertical position (ref. FIGS. 1-4).

FIG. 11 is a rear perspective view similar to FIG. 1 of an alternate embodiment dual linear array illumination system in accordance with the invention, the illumination system comprising two linear array light bars mounted for simultaneous linear movement by the elevator unit for photographic capture of the subject by a digital scanning camera.

FIG. 12 is a right side view of the illumination system, subject and camera shown in FIG. 11.

FIG. 13 is a front perspective view of the illumination system and camera shown in FIG. 11.

FIGS. 14 and 15 are alternate perspective views of a second alternate embodiment illumination system in accordance with the invention.

FIG. 16 is a front perspective view of a third alternate embodiment illumination system with the light bar movable along a curved linear path.

FIG. 17 is a front perspective view of a fourth alternate embodiment illumination system comprising a cable or chain drive.

FIG. 18 is a block diagram of a first control system suitable for use with an illumination system of the invention.

FIG. 19 is a block diagram of an alternate control system.

FIGS. 20-22 are alternate perspective and top views of an alternate embodiment with pivoting light bar segments.

FIG. 24 is a perspective view of an embodiment with a generic drive and drive elements for the light bar.

Reference numerals shown in the drawings include the following items discussed in detail below:
10—illumination system
12—base
14—elevator unit
16—light bar
16a—lower light bar 16 of dual system 110
16b—upper light bar 16 of dual system 110
18—horizontal legs
20—cross brace
22—height-adjustable leveling screw pads
22A—knobs on leveling screw pads
24—upright side plates
26—elevators
28—elevator support braces
30—cross brace
32—frame structure
32A—frame structure feet
34—pivot pin
36—radial positioning pins
38—openings
40—linear motion slide assembly
42—guide bar shafts
44—slide carriage
46—linear bearings
48—ball screw
50—ball nut
52—speed reducer
54—servomotor
54A—resolver
56—servo motion control unit, analog and/or digital controls (digital control unit)
58—coupling
60—mounting bar
62—light unit
64—connector plates
66—“home” position switch
68—fasteners (e.g., threaded knob or quick-release fasteners)
70—shroud/reflector
70A—open front
72—actuation bar for “home” position switch
74—lights
76—over-travel pin
78—polarizing filter
80—ends
82—positioning/alignment quick-release pins
84—end of stroke stop
86—input module
88—signal processing and control module
90—output module
92—input unit
100—a photographic subject
102—camera (digital or film media, or nontraditional image capture)
104—polarizing camera lens filter
110—alternate illuminating system
112—light bar support brackets
120—scanning digital camera
210—second alternate illuminating system
212—horizontal cross-drive base
216—vertical light bar
240—linear slide assembly
254—servomotor
254A—resolver
264—connecting plate
264A—angled bracket
310—third alternate illuminating system
312—horizontal base
316—vertical light bar
348—drive element connection
364—light bar support
410—fourth alternate illuminating system
414—elevator unit
464—connector plates
490—linear motion drive
492—rotary drive elements
494—linear motion transfer elements
496—brake or clutch type device

While the invention is susceptible of various modifications and alternative constructions, certain illustrated embodiments have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

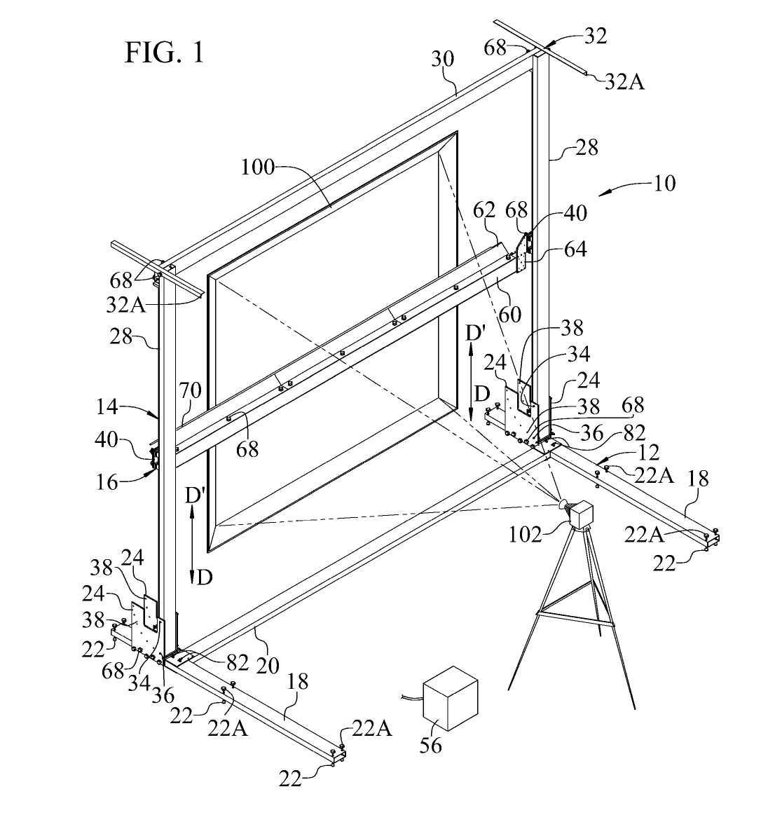

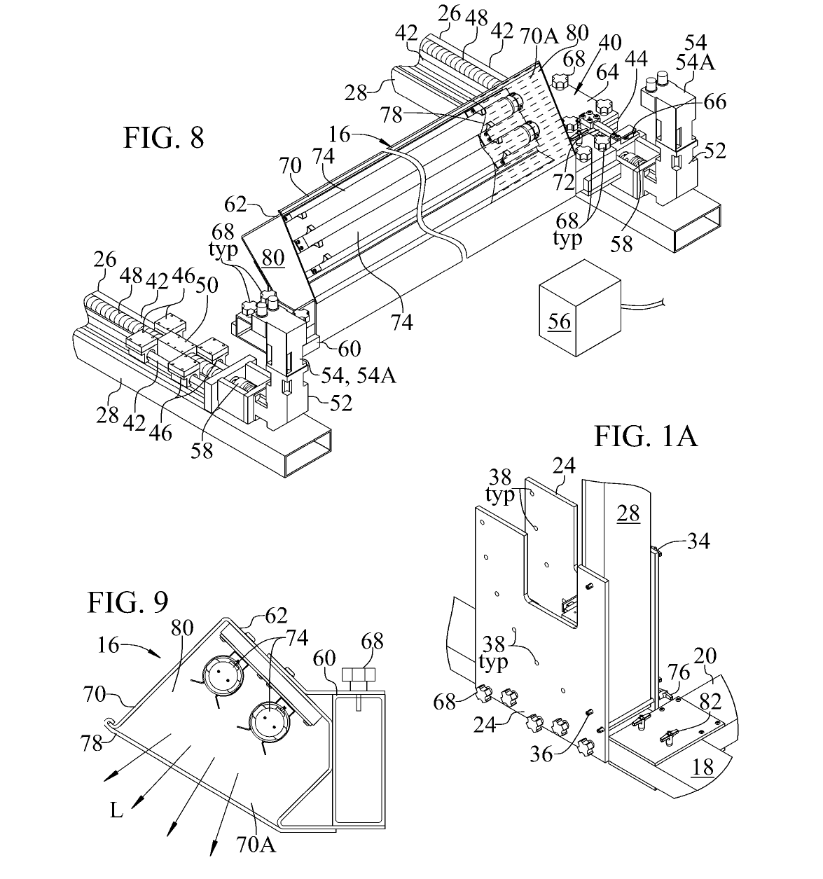

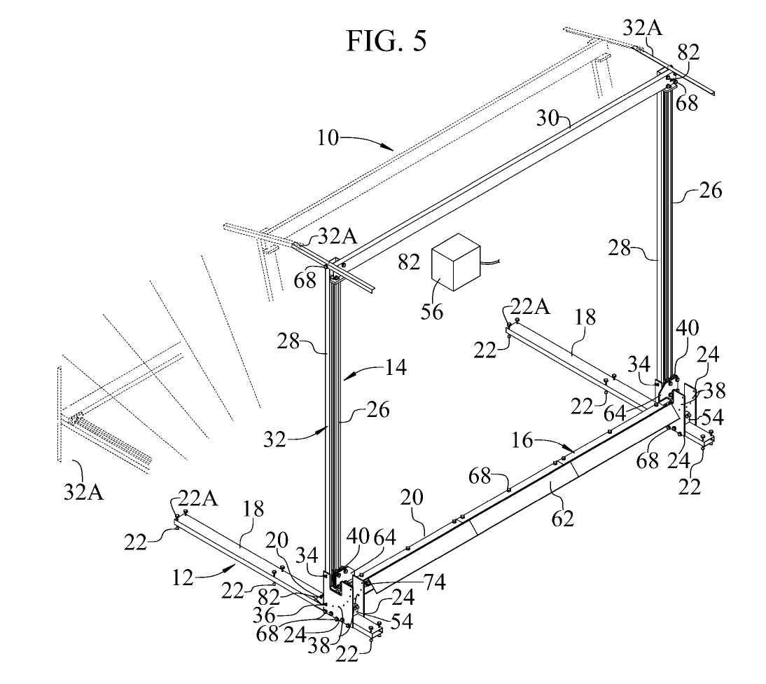

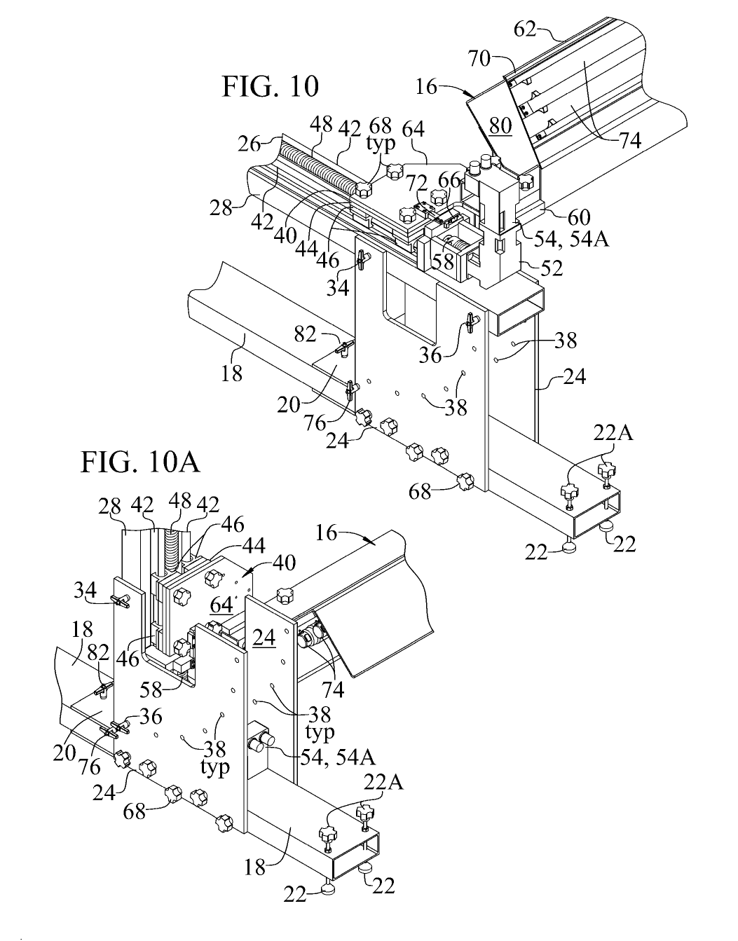

For purposes of illustration, one preferred embodiment illuminating system in accordance with the invention is shown in the drawings as illumination system 10 (FIGS. 1-10). This system is uniquely adapted for precisely controlled, consistent illumination of a wide variety of photographic subjects. The system is configured for operation in a vertical position, a horizontal position, and at operative positions therebetween to enable illumination and photographing of subjects with varied orientations. The system is also configured for folding as well as ease of disassembly and assembly for ease of transport to the location of the subject, to enable illumination and photographing of subjects in various environments.

Referring to FIG. 1, the illumination system 10 includes a frame or base 12, an elevator unit 14 pivotally mounted to the base for positioning horizontally, vertically and at selected positions therebetween, a light bar 16 mounted to the elevator unit for linear movement to establish a generally planar region of illumination, and a control unit 56 comprising automated digital controls to control operation of the elevator unit and linear movement the light bar and to interface with camera controls as applicable.

To photograph a subject, the illumination system 10, and in particular, the light bar 16 is located between the subject and a camera positioned to view the entire subject (or that portion of the subject to be photographed) as generally indicated with diverging dashed lined in FIG. 1. With the camera shutter open, the elevator unit 14 moves the light bar 16 linearly through the field of view of the camera (i.e., the camera's field of view of the subject) to progressively illuminate the subject. The control unit 56 controls the linear speed of the light bar at a prescribed speed or speeds, and optionally the intensity of the illumination from the light bar, to obtain the desired illumination characteristics for photographic exposure of the subject, while maintaining integration with camera controls and/or digital camera drivers as applicable for the camera and photographic session parameters. Typically, the linear speed of the light bar is precisely controlled at a constant speed to obtain constant or even maximum illumination over the entire subject.

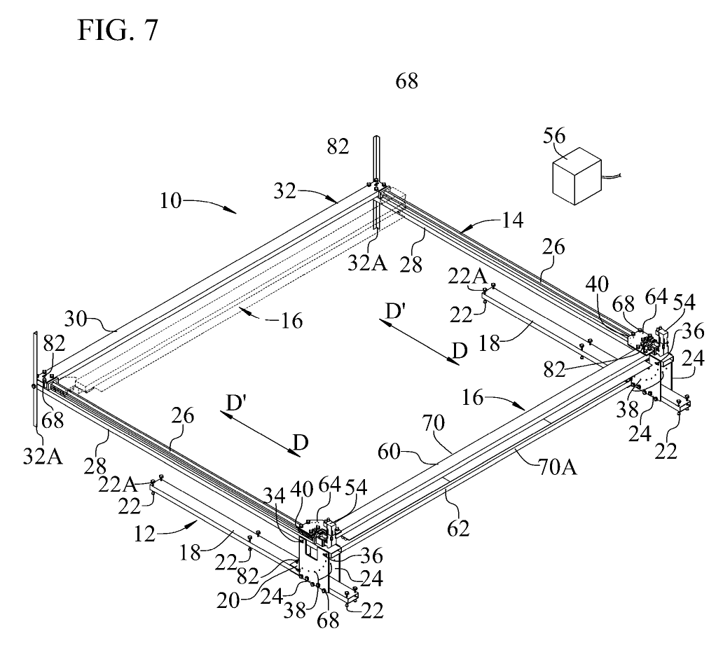

In the configuration and setup shown in FIGS. 1-4, the elevator unit 14 is positioned vertically, and the light bar 16 is actuated vertically, scanning from top to bottom as indicated by directional arrow D to progressively illuminate along the height of a vertical subject in front of the light bar, such as indicated at 100, for photographing with camera 102 located behind the light bar. The light bar is then returned to the top of the unit, indicated by directional arrow D′, prior to the next photographic exposure. In the embodiment show, the camera is provided with a polarizing filter 104 to reduce glare in the photographic capture of the subject. To photograph a subject with a non-vertical orientation, the angular position of the elevator unit is adjusted to run generally parallel to the surface of the subject to be photographed, and the light bar is drawn to progressively illuminate the subject. For example, to photograph a Persian rug in place on a floor, or an object permanently installed into a floor, the elevator unit is adjusted to a horizontal position as shown in FIG. 7, and the light bar is actuated linearly through a horizontal plane to progressively illuminate the subject for photographing with a camera positioned above the light bar.

The base 12 shown includes a pair of laterally spaced, horizontal legs 18 and a cross brace 20 secured between the legs to establish a footprint configured to support the elevator unit 14 and light bar 16 on a horizontal surface such as a floor or a table top. The base is sized as a stable framework or platform for the elevator unit and the light bar in all angular positions of adjustment. The base (i.e., the legs and cross-brace in the embodiment shown) is further configured to not obstruct the view (from above) of the limits of the operative plane of illumination provided by the travel of the light bar when the elevator unit is positioned horizontally as in FIG. 7. Accordingly, the cross-brace 20 is located at or beyond the end of the horizontal stroke of the light bar, and the legs 18 are laterally aligned under or outside the components (discussed further below) of the elevator unit. Height-adjustable leveling screw pads 22 mounted to the legs, or other leveling apparatus can be provided, for accommodation of a not level or uneven surface. The height of the pads 22 shown are thread-height adjusted with knobs 22A to bring the base into a stable supporting condition after the base is initially setup at the location of the photographic shoot. Alternate configuration base arrangements will be provided to, for example, establish support from an inclined or vertical surface or structure, or overhead or ceiling structure, and alternate leveling systems may be used for adjustment of the base into stable supporting condition from such surfaces or structures. Such alternate configurations may include clamps, connectors, fasteners, clips and other mechanical arrangements.

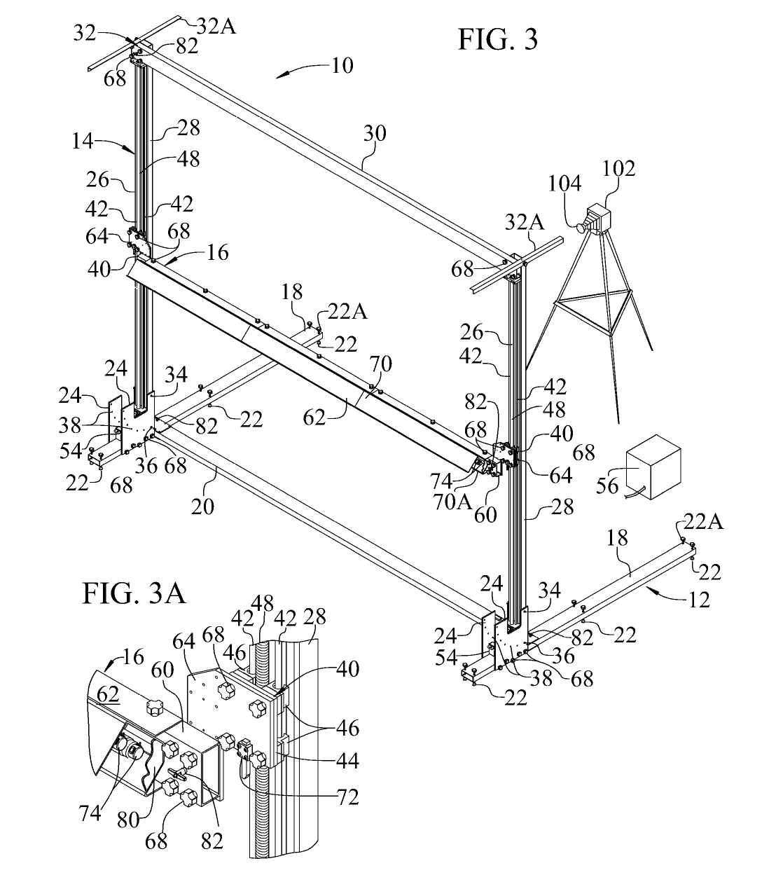

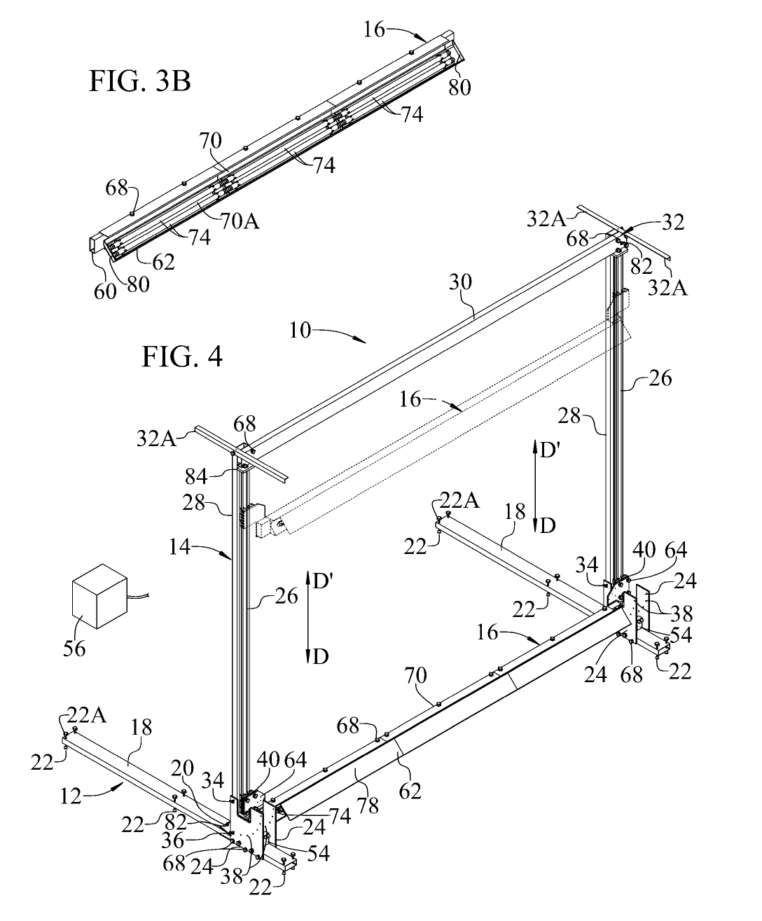

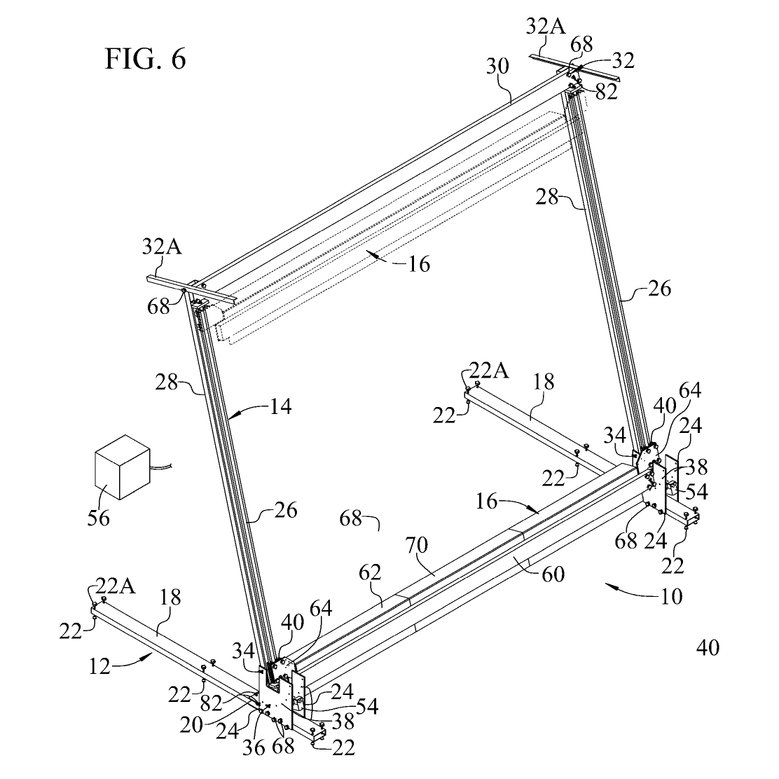

As shown in FIG. 3, the elevator unit 14 includes a pair of elevators 26 mounted on parallel, laterally spaced support braces 28. A cross brace 30 is connected between the upper ends of the support braces to establish a dimensionally stable frame structure 32 for the elevator unit and light bar mounted to the base 12. The lower ends of the support braces are pivotally supported in pivot mounts, shown as trapped between two pairs of upright side plates 24, secured to the forward end portions of each of the legs 18. Pivot pins 34 extend horizontally through aligned openings in the lower ends of the support braces 28 and the pairs of plates 24 for swinging of the braces, and thus the frame structure, elevators and light bar about a horizontal axis, through approximately ninety degrees between the generally vertical position shown in FIG. 1 and the generally horizontal position shown in FIG. 7 laterally aligned over the legs 18. Radial positioning pins 36 are slidably positionable through selected pairs of aligned openings 38 in the upright plates and a second opening in the support braces 28 to secure the support braces, and thus the frame structure, elevators and light bar in selected angular positions, such as in fifteen degree increments (represented with dashed lined in FIG. 6) between the vertical and horizontal positions. Over-travel pins 76 extend horizontally through aligned openings in the lower back ends of the pairs of plates 24 to prevent inadvertent pivoting of the elevator unit forwardly past vertical when positioning and adjusting the angular position of the elevator unit and removing and installing positioning pins 36. The back portion of the base (i.e., rearwardly of the upright plates 24) is sized to support the elevator unit and light bar in all of its available angular positions established by the positions of the openings 38 in the side plates. The upper end of the frame structure is provided with laterally spaced feet 32A to further support the free end of the elevator unit from the horizontal surface (e.g., the floor) when the elevator unit is in its horizontal position.

The elevators 26 each comprise a ball screw and ball nut (or lead screw and lead nut) driven linear motion slide assembly 40 mounted to a support brace 28. Referring to FIGS. 3A, 8 and 10A-B, the linear slide assemblies each include two opposing guide bar shafts 42, a slide carriage 44 carried on four linear bearings 46 (two linear bearings per guide bar shaft), with a ball screw 48 positioned between the two guide shafts 42 and a ball nut 50 mounted to the underside of the slide carriage 44, centrally between the four linear bearings. Two independent servomotors 54 drive the two elevator slide assemblies 40 independently. Each servomotor is coupled to the end of a ball screw 48 through a speed reducer 52 and coupling 58 for controlled rotation of the ball screw and resulting linear motion of the slide assembly. The drive system, including the servomotor, the speed reducer, and the coupling, is preferably specified to minimize backlash, to reduce linear positioning errors and enhance linear motion accuracy of the light bar. Synchronized motion of the two parallel slide assemblies, to linearly move the light bar, is accomplished by a multiple axis, coordinated, servo motion control unit 56. The servo/reducer coupling 58 is preferably a curved beam coupling, a helical coupling, or another coupling configured for self-alignment and to operate with minimal to essentially zero-backlash. A rotary resolver 54A is coupled for rotation with the servomotor to provide angular position feedback to the control unit 56 for closed loop control of the movement of the light bar. “Home” or “0.00” (zero) position switches 66 such as cooperating with switch actuation bars 72 carried for movement with the slide assemblies (shown carried on connector plates 64), or other position signal generators, are located at one end of the linear stroke of each elevator to establish baseline position information for the individual elevators. With the light bar removed, the system controls drive the two elevators, individually, through a homing cycle to precisely position and verify that the two elevator carriages are running synchronized and parallel to each other. The preferred screw drive linear slide assemblies are capable of operating very smoothly with low friction and virtually zero backlash or slack in motion. Whereas, for example, due to tension side versus slack side of a gearbelt or cable or chain drive, initial and reversing movements would tend to be more jerky than with the screw driven linear slide, although such drives may be suitable for certain implementations of the invention. Screw and nut drives also generate a positive mechanical advantage, whereas, for example, pulley and chains or belts have a negative mechanical advantage.

The light bar 16 includes a mounting bar 60 and a light unit 62. The mounting bar extends laterally across the width of the system, and is connected at the ends to the slide assemblies 40 through connector plates 64 with fasteners 68 such as threaded knob fasteners shown and/or quick-release fasteners. The light unit 62 establishes a linear light array with one or more linear light sources such as tubes, bulbs, LEDs (an LED array) and neon of any applicable wave length spectrum. In the embodiment shown, light tubes 74 (see FIG. 3B) extend parallel in relative close proximity with one another, and are assembled in a shroud/reflector 70 with an open face 70A through which a band of light “L” projects for illumination of the subject. The shroud/reflector is connected to and extends laterally along the length of the mounting bar 60. The shroud/reflector includes the open front 70A, closed upper, lower, and back walls, and preferably closed ends 80, although several of the figures in the drawings are shown with one or both of the closed ends removed or partially broken away for convenience of viewing internal components of the light bar. The light array extends along the length of the shroud/reflector to establish an even spread of light and even illumination projecting forwardly through the open front 70A along the length of the shroud/reflector. The light sources shown are fluorescent, but may be LEDs, x-ray, neon, infrared, ultraviolet or a similarly characteristic lights that cooperate to establish a linear light array light source. The open front 70A of the shroud/reflector is oriented facing downwardly at an angle of approximately forty-five degrees from horizontal with the light bar positioned for vertical movement, stroking downwardly (D) during the photographic exposure. The inside surfaces of the shroud/reflector are reflective flat white to promote reflection of all light from the array through the open front 70A of the shroud/reflector. A polarizing filter film or rigid polarizing filter plate 78 is secured to the open front 70A of the shroud/reflector, such that the light produced by the light bar passes through the polarizing filter to reduce light reflections from the subject being photographed. This polarizing filter has been found to be especially advantageous when used with a fixed shroud/reflector in eliminating glare during photographic capture on film media. All outside surfaces of the shroud/reflector and light bar, as well as preferably all other surfaces potentially in the field of view of a camera, are non-reflective flat black.

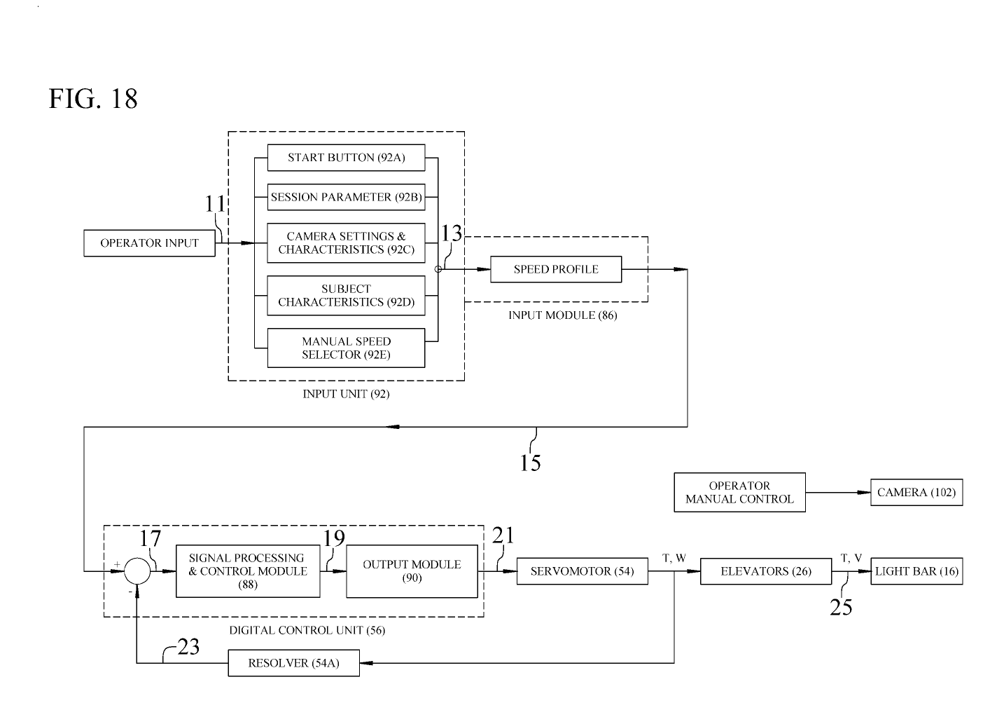

A block diagram of a manually operated control system suitable for use with the illumination system 10 is shown in FIG. 18. In this embodiment, precise linear movement and control of the light bar 16 is obtained with the servomotors 54, resolvers 54A, low-backlash linear drive elements (e.g., elevators 26) and a closed-loop digital control unit 56. The digital control unit 56 receives input information (indicated at 15) as to the desired movement characteristics (e.g., speed profile) of the light bar, and processes that information to provide control signals 21 to the servomotors to effect control of the timing, position and speed the elevators and the corresponding linear movement of the light bar. The resolvers are connected with the servomotors to establish a feedback signal 23 indicative of the servomotor position and speed to close the control loop around the control unit and effect highly accurate movement of the light bar.

The system controls include (i) an input unit 92 with a start button 92A, optional parameter setting apparatus indicated at 92B-E, and an input module 86, (ii) the control unit 56 with a signal processing and control module 88 and an output module 90, and (iii) the feedback resolvers 54A. The input unit 92 is controlled by the operator setting or selecting or activating (as indicated at 11) one or more of the optional manually configurable conditions or parameters (92B-E) utilizing any convenient arrangement or devices such as but not limited to buttons, jumpers, switches, potentiometers, etc., and then initiating operation of the system with the start button. The input module 86 receives the information from the parameter setting apparatus as indicated at 13, establishes via appropriate transfer functions the signal 15 indicative of the desired speed profile of the light bar for the photographic session based on such parameters, and provides that signal to the digital control unit 56 to obtain operation of the light bar and resulting illumination characteristics based on the manually established conditions and parameters.

The input module 86 is configured for either analog and/or digital input 13, such as ranging from the simple start button to multiple optional operator established parameters based on, for example, photographic session parameters 92B, camera settings and characteristics 92C, characteristics of the photographic subject 92D, and/or other hardware or setup conditions. Each of the operator established parameters have an affect on the desired speed profile signal 15 from the input module. The manual speed selector input 92E enables the operator to, for example, (i) specify a fixed speed signal for movement of the light bar at a constant speed profile, (ii) select from one of several pre-established speed settings, or (iii) specify or select a profile that varies the speed of the light bar. Specifying camera settings (at 92C) will adjust the speed profile according to a pre-established schedule or signal transfer function such as digitally through a look-up table or with a manually adjustable analog device. Similarly, each of the other operator configurable input parameters are implemented to adjust the speed profile and resulting operation of the light bar in accordance with associated pre-established signal transfer functions. Where no manually configurable input apparatus is provided, the input module will be configured to provide a constant signal for obtaining a constant speed profile in the movement of the light bar upon initiation by the start button. In preferred embodiments, the parameter setting apparatus and start button of the input unit are provided in a portable device that is operably connected (wired or wireless, for signal transmission) to a main controller box such that this part of the input unit can be carried to and actuated by the photographer at the camera while controlling operation of the camera or attending to other activities away from the illumination system.

The module 88 is an automated digital processing unit operably connected to receive the speed profile input 15 (as trimmed to 17 by feedback 23) from the input module 86 and produce an output signal 19. In typically a microcontroller device, signal processing, closed-loop control processing, and operational logic functions are carried out in the processing module 88 based on the resultant signal 17. The processing module also includes an algorithm to cause the elevators to individually (with the light bar removed) go through a “homing” cycle when activated by a reset-type switch (not shown) in the input unit. For embodiments with a single linear drive unit, this homing cycle may be programmed to cycle automatically, such as at power-up of the system. The output module 90 interfaces with the processing module to receive the output 19, and provide suitable power drive 21 to the servo-motors 54 to effect powered operation of the linear drive unit and movement of the light bar responsive to the output 19 from the processing module. Controlled output variables shown in FIG. 18 at the servomotor are T (time) and W (rotational speed of servomotors), with output variables 25 including V (linear speed of light bar) to obtain the desired speed profile and corresponding illumination characteristics during a photographic session. Those skilled in the art will readily appreciate that additional or alternate control systems and variables may be utilized in implementing control of the illumination system.

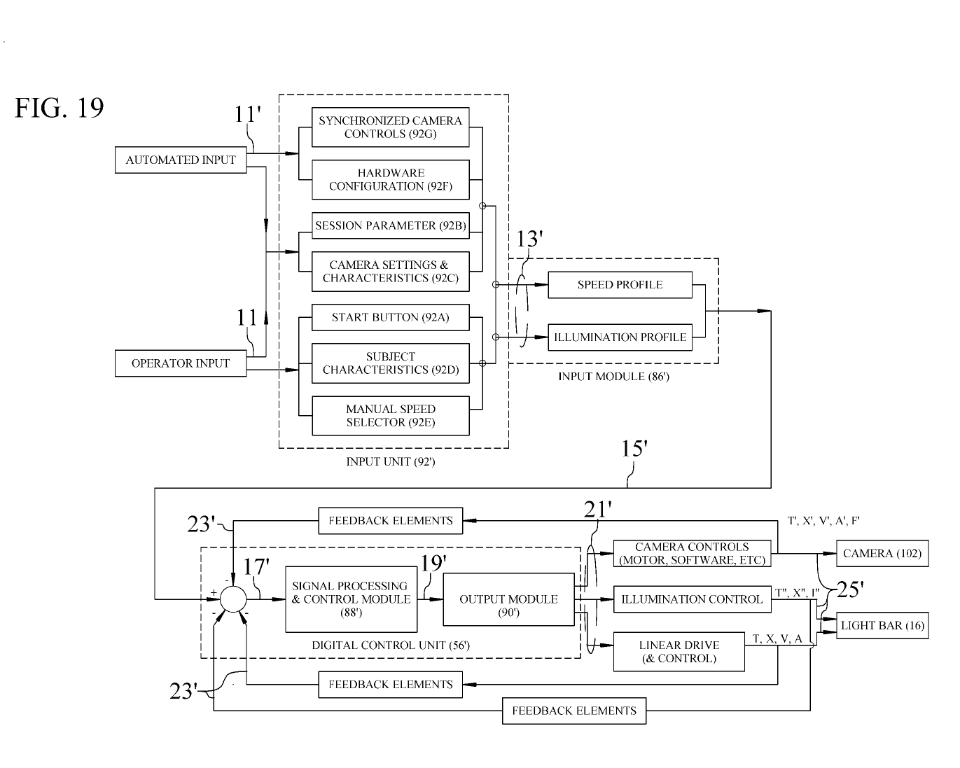

As further illustration, a block diagram of a general control system for use with the illumination system 10 is shown in FIG. 19. This system includes provision to control the speed profile (i.e., movement) of the light bar 16, the illumination profile (e.g., intensity, wavelengths and other characteristics of illumination) of the light bar, and operation of the camera. Thus, this control system can be configured for synchronized operation of the light bar and the camera.

In this instance, the input unit 92′ is activated or controlled by the operator (indicated at 11) as well as automated controls (indicated at 11′). Parameter setting apparatus such as 92A, 92D and 92E are shown as manually controlled, while apparatus 92B-C are configured for either manual or automatic control. The automated input can also include, for example, detection and input based on hardware configuration (92E), and input such as from controls (92F) (e.g., digital, software) connected for synchronized operation of an analog or digital camera, or another automated control device. These parameters are provided at 13′ to the input module 86′ which embodies transfer functions for both speed profile and illuminations profile, and which thereby provides “input” signal 15′ to the digital control unit 56′ that is indicative of the desired illumination characteristics (e.g., constant illumination, varied illumination profile) and the desired movement of the light bar (e.g., constant speed profile, varied speed profile). As noted above, the input module may be configured to accept either or both analog and digital input, and in preferred embodiments, is provided, at least in part, in a portable device such that it can be carried to and actuated by the photographer at the camera, or in a remotely located device for actuation by the camera or by a system integrated computer (e.g., a microcontroller device). The digital control unit 56′ receives the input information 15′ as to the desired operational characteristics of the light bar, and processes that information through the signal processing module 88′ and output module 90′ to produce and provide control signals 21′ (i) to the power drive control device and linear power drive unit 54′ to effect accurate control of the timing, position and speed of linear movement of the light bar, (ii) to the illumination control device, and to the (iii) camera controls. In general, the power drive unit can be any suitable rotary power drive controllable devices such as stepper motors or synchronized motors with rotary to linear conversion, or linear motors or linear drive arrangements for appropriately configured illumination systems. Controlled output variables shown in FIG. 19 are time (T, T′, T″″), position (X, X′, X″), velocity (V, V′), acceleration (A, A′), illumination characteristics (I″), and camera settings (A′, F′).

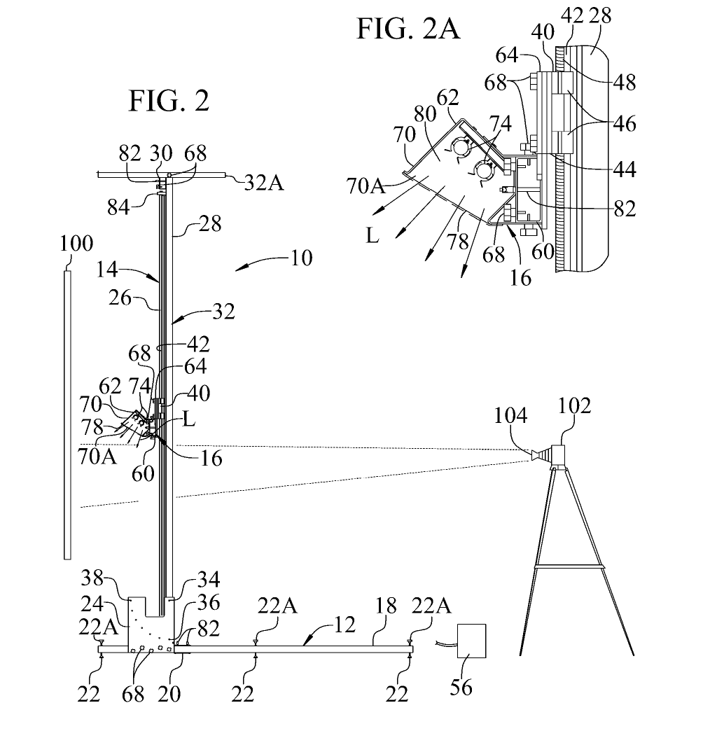

Referring to FIGS. 1-3, to photograph a vertical subject such as wall mounting 100, the illumination system is positioned between the camera 102 and the subject such that the camera views the subject between the elevators 26 and through the open frame structure 32. Illumination of the subject begins with the light bar 16 positioned to illuminate the top of the subject, typically against the stop 84 at the top of the elevators, and progresses as the light bar strokes from top to bottom (direction “D”) by the elevators. As the light bar scans downwardly it progressively illuminates, and the photographic media captures a band of the subject below the light bar as indicated with the diverging dashes lines in FIG. 2 until the entire subject has been illuminated and captured in the photographic media. Throughout the process, the camera sees the subject above the light bar, however, the photographic media ignores this part of the subject as the corresponding portion of the capture media has already been fully exposed. The camera also sees the subject below the light bar, and progressively captures that part of the subject until it has been exposed to full illumination of the light bar. The system controls are implemented as described above to achieve the desired illumination control, either constant of responsive to the input parameters of the particular system and photographic session.

To photograph a non-vertical subject, the light bar 16 is first rotated or otherwise reoriented to face in the opposite direction, to illuminate rearwardly and downwardly with the elevator unit in its upright position. The light bar shown is (i) removed from the front side of the connector plates 64 (by removing fasteners 68 and pin 82), (ii) rotated 180 degrees to face the opposite direction, and, (iii) as shown in FIGS. 6-7, secured to the back side of the connector plate (with fasteners through the ends of the mounting bar 60). Illumination and photographing of a subject such as having an inclined surface will proceed as described above, but with the elevator unit secured into an inclined position (e.g., FIG. 6), the subject positioned at the back-side of the elevator units, and the camera positioned forward of the system with its field of view of the subject through the inside of the frame structure.

To illuminate and photograph a horizontal subject, such as laid out on the floor or a table top on which the system is supported, the elevator unit is pivoted into and secured the horizontal position shown in FIG. 7, with the camera position above the illumination system with its field of view of the subject again framed by the frame structure and elevator unit. Alternately, the light bar can be pivotally mounted to the slide assemblies 40 for selective positioning forwardly and downwardly, or rearwardly and upwardly with the elevator unit in its vertical position. In this instance, scanning illumination of a horizontal subject below the elevator unit will proceed in the opposite direction, progressing from the position proximate the lower cross-brace 20 towards the upper cross-brace 30. Provision of a pivotally positionable light bar will also permit direction adjustment of the light bar (i.e., the orientation of the open face 70A through which the illumination band is provided) for particular photographic session parameters.

With the foregoing arrangement, the illumination system 10 can be folded and/or broken down into various constituents for ease of transport and storage. Positioning the frame structure 32 and elevator unit 14 parallel to the base 12 (as described above, and as shown in FIG. 7) results in a narrow, compact unit that can be stored or transported in a relatively narrow space. In the embodiment shown, the major components of the illumination system are releasably connected together with fasteners 68 and/or quick-release alignment/positioning pins 82. In particular, the lower cross-brace 20 is releasably secured to the legs 18 through overlapping braces or plates, and the side plates (pivot mounts) 24 are releasably secured to the legs. The entire frame structure 32 and elevator unit 14 are removable from the base with removal of the pivot pins 34 and radial positioning pins 36. The upper cross-brace 30 and feet 32A are releasably secured to the side braces 28. The light bar 16 is removable from the connector plates 34, and if desired, the light unit 62 is removable from the mounting bar 60. Position/alignment pins 82, preferably of the quick-release type, are provided to facilitate ease of assembly and disassembly of the several major components of the system as discussed above. As a result, the entire system can be quickly and easily disassembled into the individual components, stored and/or transported in this disassembled condition, and reassembled for photographing a subject in a location other than a studio. This tear-down capability is particularly advantageous in large illumination systems. And provision of the manually-operable threaded knob fasteners 68 and quick-release pins 82 enables disassembly and assembly without the need for extensive tools, further promoting ease of use of the system at a location remote from a studio.

For further instructive purposes, a detailed description of certain aspects of a prototype unit follows. It will be understood that this discussion is not to be construed in a limiting manner, but rather as illustrative of typical design considerations in implementing the invention, as well as certain features, characteristics and advantages thereof. A prototype illumination system in accordance with the invention was constructed as generally shown in the first embodiment in the drawings (FIGS. 1-3, et al.) and described above, with overall dimensions of 14′ wide×8′ deep×12′4″ tall. This unit is capable of evenly illuminating a photographic subject area of 12′ wide×10′ high, with the light bar scanning vertical, horizontal and at pre-set 15 degree incremental angular positions therebetween. The sizes for the prototype unit were selected for photographing large objects such as large sculptures, large wall-mounted art and large Persian rugs in an environment with a large floor space and high ceilings. The prototype unit includes two parallel elevator assemblies as described above for coordinated linear motion of the light bar. Each of the two elevator ball screws is driven by a right-angle 10:1 planetary gear reducer and an A.C. brushless braking servomotor with individual power amplifiers and a single two-axis coordinated motion control unit. The right angle reducer was selected to minimize required mounting space. The 10:1 reduction multiplies the accuracy of the servo resolvers and reduces the motion mismatch sensitivity of the coordinated, simultaneous, motion of the two elevators. Synchronized motion of the two parallel slide assemblies moving the light bar is accomplished with a multiple axis, coordinated, servo amplifiers and motion control unit. The slide carriage top plate is mounted on and moves on four matched-centerline Teflon-lined linear bearings. Teflon linear bearings were selected for advantageous operational characteristics, including the ability to run lubrication free, they are essentially impervious to contamination, they are not damaged by normally anticipated shock loads, they are dielectric, and they run smoothly and quietly. The guide bar shafts are mounted to T-shaped profile section, aluminum rail supports. These rail supports in turn are bolted to the elevator mounting tube. The T-shaped profile inertial section adds substantial stiffness along the length of the overall elevator assembly.

It will be further understood that the invention contemplates an illumination system that is, for example, belt drive, and/or smaller in size, and therefore less costly to produce, but yet suitable for illumination of many photographic subjects. Although potentially having certain limitations as compared with, for example, the precision, digitally controlled, closed-loop system described above, such variations in design will require less space and/or expense in operation, yet still offer many of the improvements in performance and quality of photographic captures available from the scanning illumination thereof as compared with prior equipment and techniques. Alternate implementations of the illumination system may be as small as, for example, approximately 12 inches square, with a pulley and (rubber or plastic) band drive, or plastic gear and plastic gear-belt drive, for photographing jewelry. Still alternately, less precision but even larger illuminations systems may be provided such as up to a scale necessary for photographing even larger objects such as automobiles, bulldozers or yachts.

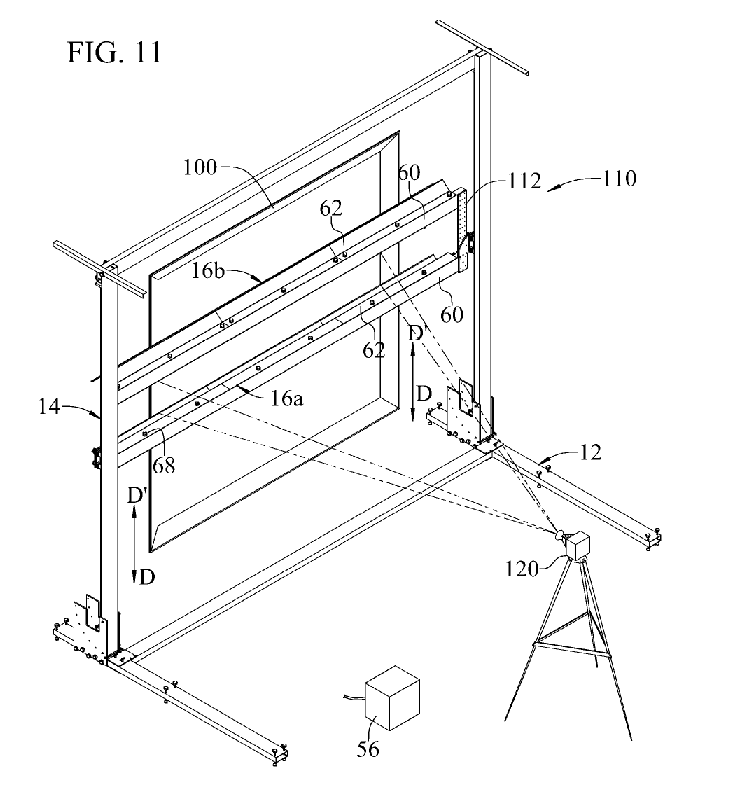

Referring to FIGS. 11-13 in the drawings, there is shown an alternate embodiment illumination system 110. This alternate illumination system is constructed essentially the same as the illumination system 10, and includes all of the components and functionality described above, but is provided with two opposing light bars spaced apart along the direction of linear movement of the elevators (i.e., vertically spaced in the position shown in the drawings) for simultaneous movement therewith. These light bars are identical to light bar 16, and are designated as 16a and 16b in the drawings to distinguish between the lower and upper positions, respectively. In the embodiment shown, the ends of the lower light bar 16a is connected to the linear slide assemblies 40 of the two elevator assemblies through connector plates 64 as described above. The upper light bar 16b is connected at a fixed distance from the lower light bar with support brackets 112 on each side of the unit, the support brackets being connected to and extending upwardly from the connector plates 64, such that both light bars move together with the slide assemblies. Spaced holes in the support brackets enable selecting or adjusting the space between the light bars according to the photographic subject and session parameters. The open front 70A of the upper shroud/reflector 70 is angled downwardly (at approximately forty-five degrees from horizontal), and the open front 70A of the lower shroud/reflector 70 is angled upwards (at approximately forty-five degrees from horizontal) so that the light projecting from the shrouds/reflectors combine therebetween to produce a single band of light and illuminate the same band of the photographic subject simultaneously for enhanced illumination of the subject as compared with a single light band. Operation and control of the dual light bar proceeds generally as described above.

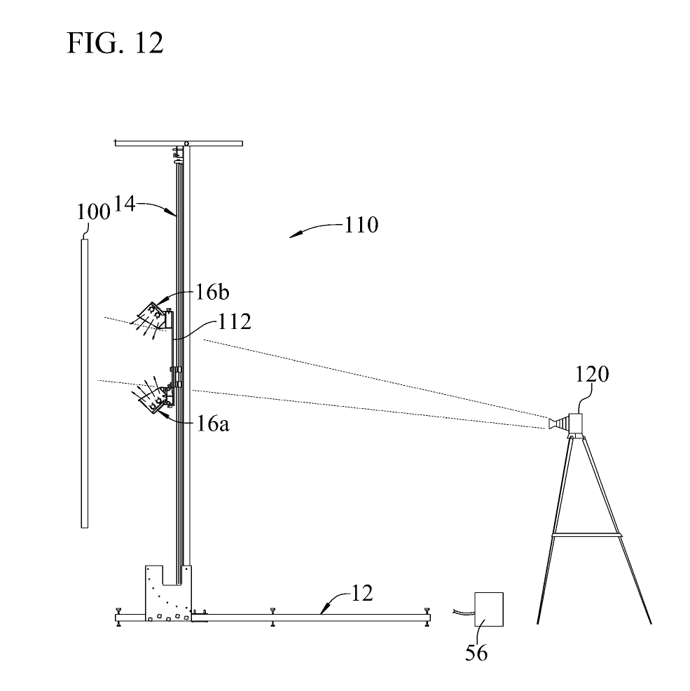

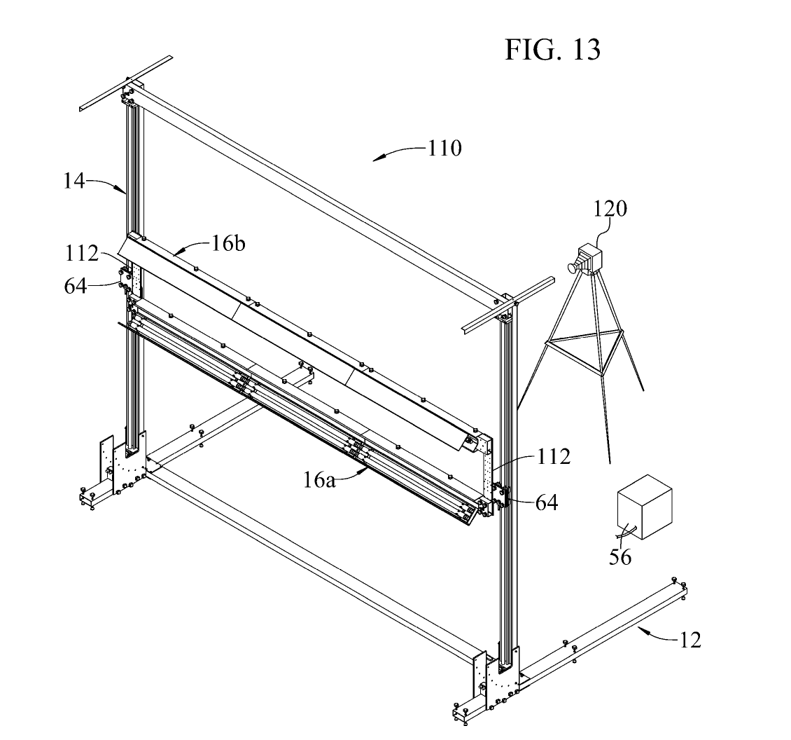

Some large recording media will benefit from this alternate illumination system 110. In addition, this alternate system is especially useful with a scanning digital camera. In this instance, the system controls are modified to control operation of a scanning digital camera 120, and exposure of the digital medium, synchronized with operation of the light bars. As illustrated with the dashed lines in FIGS. 11-12, the scanning digital camera focuses on the portion of the subject viewable between the two light bars (i.e., “reads” or captures successive parallel lines between the light bars) to capture only that part of the subject photograph at any instant in time. As the light bars move linearly to progressively illuminate the subject, the focus of the scanning digital camera moves linearly with the light bars to progressively capture the entire subject. The speed of the light bar and photographic capture by the camera is set in a speed profile established by input parameters of the photographic session. For example, feedback control with a light meter in the camera to establish calibration parameters, and calculation of the speed variable on a real-time basis for both the light source and the camera will provide synchronized variable-speed scaled motion between the camera and the light bar for a wide range of subjects and environments. Variable speed feedback control that couples the light bar with the camera can also be used to achieve a system that is capable of correcting for camera or lens deficiencies or inefficiencies.

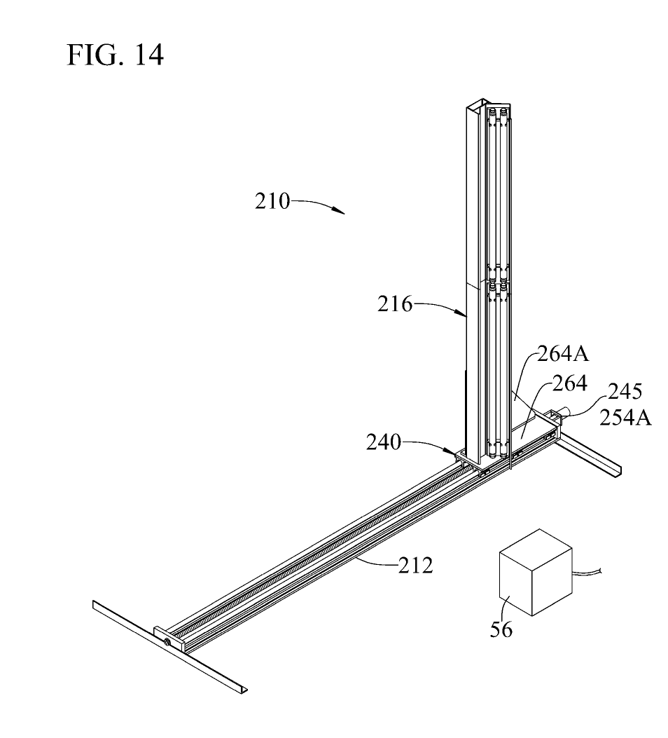

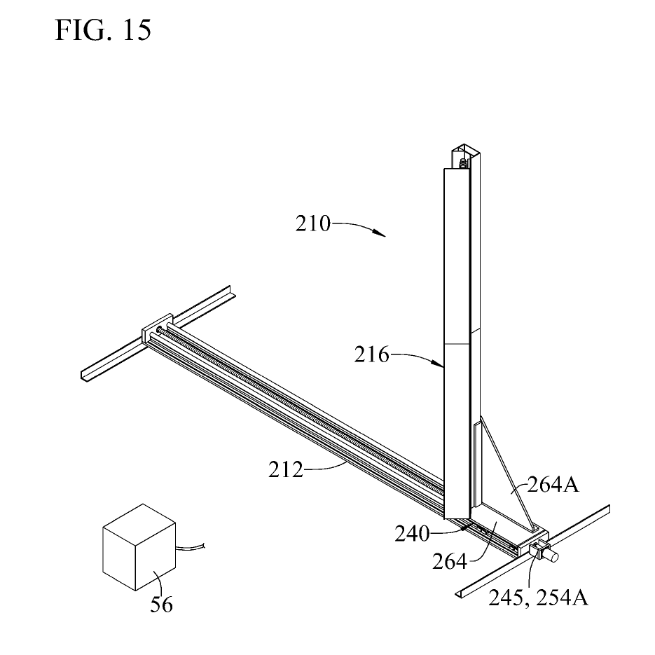

A second alternate embodiment illumination system 210 is shown in FIGS. 14-15. This alternate illumination system is also constructed with similar components and controlled for similar operation as illumination system 10, but is provided with a vertical light bar 216 that is secured at its lower end to a horizontal linear slide assembly 240 carried on a horizontal cross-drive base 212 for horizontal linear movement of the vertical light bar and progressive illumination of the subject from side to side, from the left side of the camera's view of the subject to the right side in the configuration/view shown. In this instance, the light bar is connected to the slide assembly with a connecting plate 264 that includes an angled bracket 264A to stabilize the light bar in the vertical position, and the slide assembly includes six linear bearings 46 and one or two ball nuts (not shown) engaging the ball screw 48.

Those skilled in the art will readily appreciate that additional alternate embodiments may be provided within the scope of the invention. For example, the horizontal elevator unit 14 and light bar 16 as presented in FIG. 7 can be supported at a relatively substantial height above an upwardly facing horizontal surface (e.g., a floor) for illuminating upwardly, and progressing scanning and illuminating a downwardly facing (e.g., horizontal) surface spaced above the floor at sufficient height for positioning a camera below the operative elements of the illumination system and object for a photographic capture of the object. Linear drive of the light bar can be provided by linear motors.

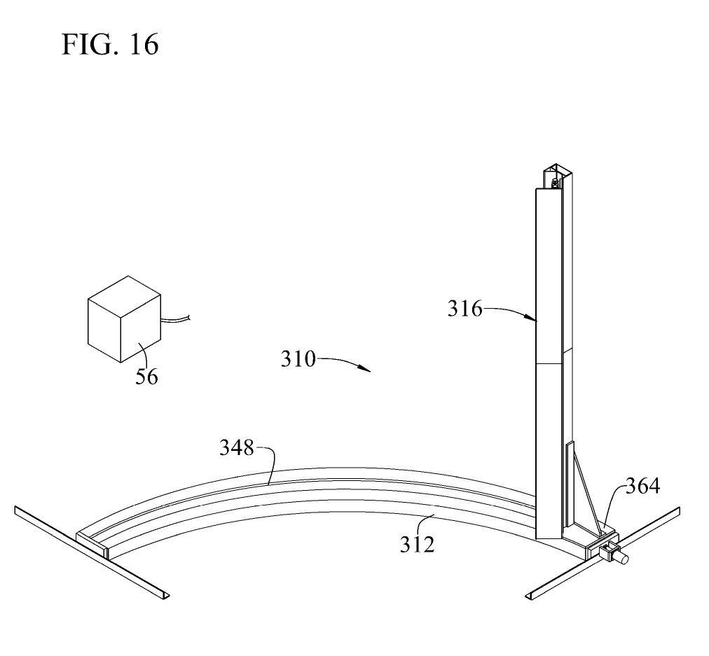

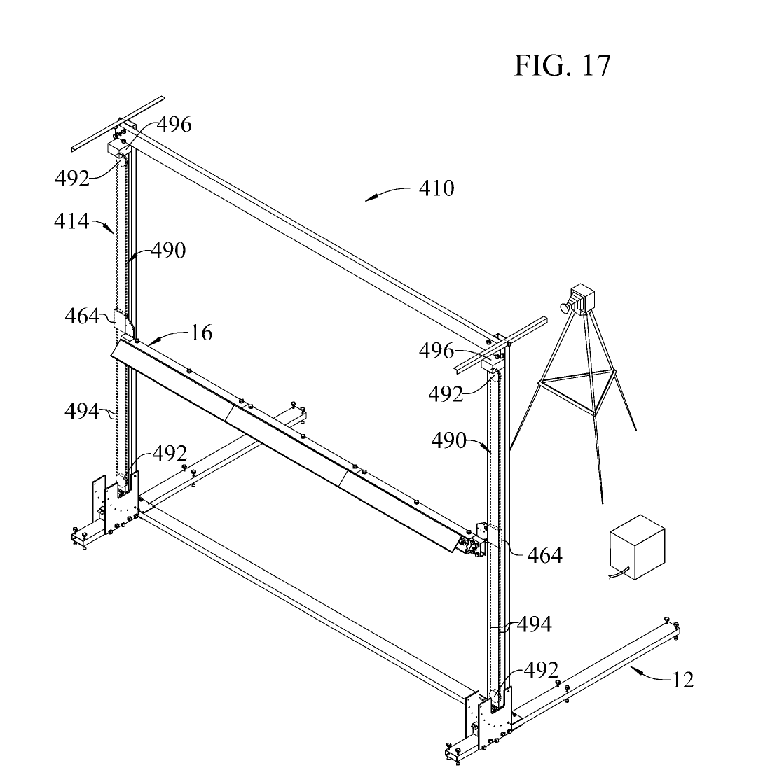

As further nonlimiting examples, third and fourth alternate embodiment illumination systems 310 and 410 are illustrated schematically in FIGS. 16 and 17. In general, these alternate embodiments include components and operations as will be understood from the descriptions of illumination systems 10, 110 and 210. The illumination system 310 includes a vertical light bar 316 secured at its lower end to a linear motion assembly located within the horizontal base 312, and a support 364 for the light bar. The linear motion assembly is operatively connected to drive elements as indicated at 348 also located within the base for moving the linear motion assembly and light bar (and support) through a horizontal curved path corresponding to the curved slot shown in the top of the base. In this instance, the ball screw and ball nut drive arrangement described above will be replaced with drive elements suitable to obtain controlled movement of the light bar along the curved path. This system 310 is uniquely suitable for illuminating a horizontally curved photographic subject (i.e., a subject with a surface or side to be photographed that is substantially vertically straight but horizontally curved) by providing a light bar that progresses along a curved path around the subject and thereby progressively illuminates the subject. To the extent that the curvature of the path tracks the curvature of the subject, a substantially constant, maximum intensity illumination of the subject is easily provided with a constant intensity level of illumination and the substantially constant distance between the light bar and the subject. Alternately, for example, the intensity level of illumination can be varied according to a function or relationship between the subject and the light bar, or otherwise, as the light bar travels through the path. In contrast, the horizontal light bar 16 of the illumination system 410 is driven linearly on the elevator unit 414 with an internal linear motion drive 490 comprising rotary drive elements 492 located at the upper and lower ends thereof and linear motion transfer elements 494 connected between the rotary drive elements and the connector plates 464. In this instance, powered rotation of either rotary drive element with an electric motor (e.g., servo-control motor, not shown) causes controlled linear motion of the light bar responsive to the system controls. Such an arrangement enables use of pulleys or sprockets and dual cables or chain drive or gearbelt elements (or similar drive elements) for implementation of a chain drive or cable drive that is less expensive than the ball screw type unit shown in system 10, with backup motor brakes or friction clutches or other devices as generally indicated at 496 provided to prevent the light bar from inadvertently dropping should the chain or cable break during operation of the system. As will be apparent to the skilled artisan, any suitable drive and drive elements may be specified in accordance with the invention, as indicated by the dashed-line boxes 690 shown on system 610 in FIG. 23.

In a certain preferred system, method and apparatus, in accordance with the invention, for illuminating a subject smaller than the available stroke of the light bar, the light bar is operated through an illumination stroke that includes a short stationary dwell time at the beginning thereof, with an initially slow speed increasing to a faster, constant speed during illumination of the subject. Additional methods of the invention will be evident from the description herein and the accompanying drawings.

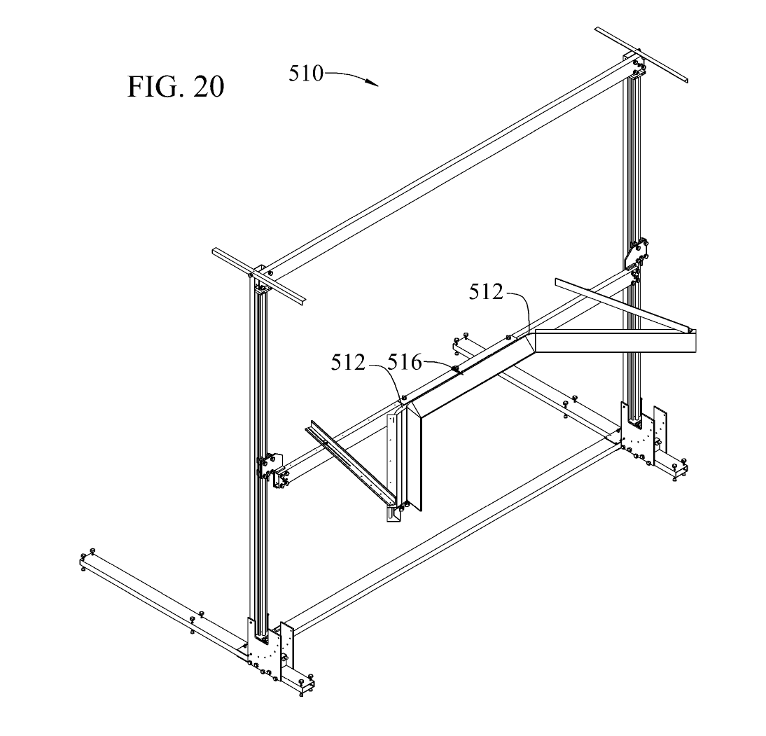

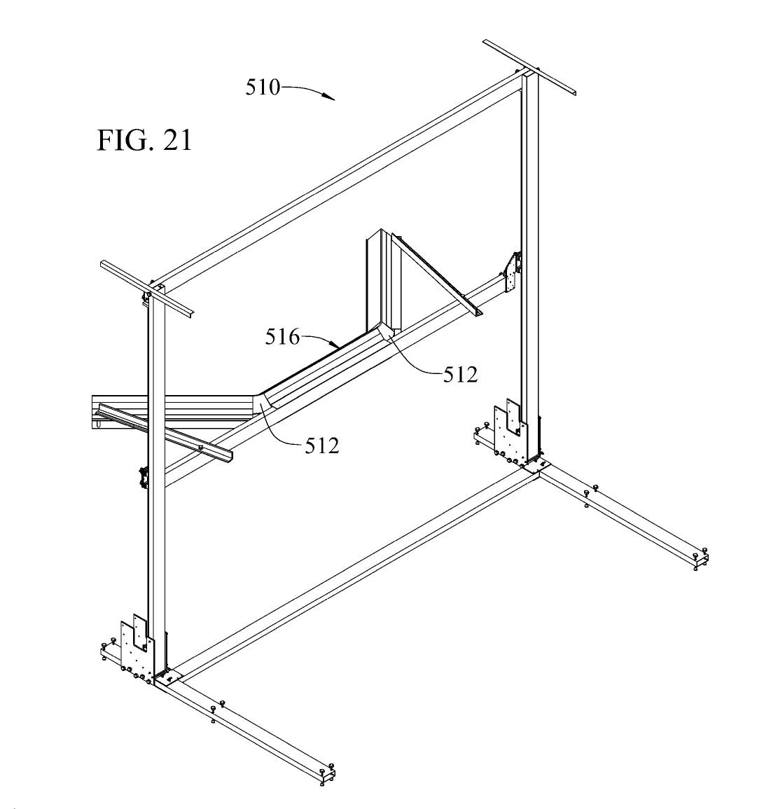

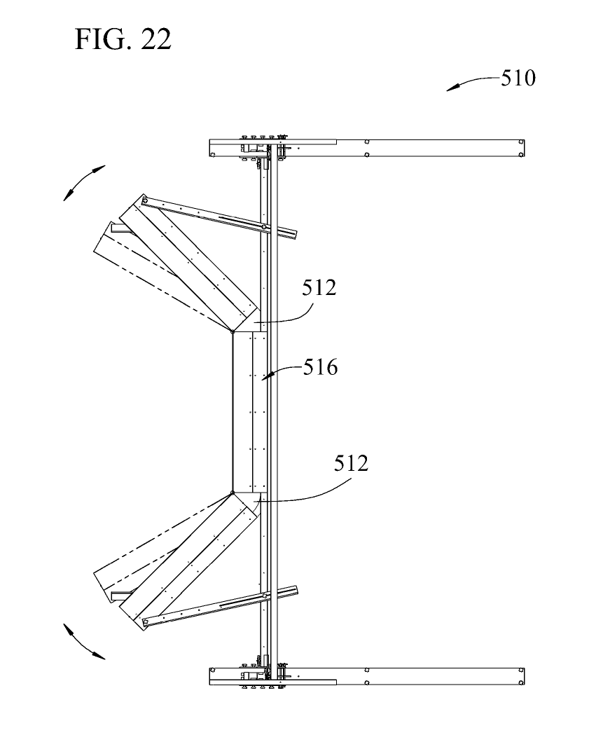

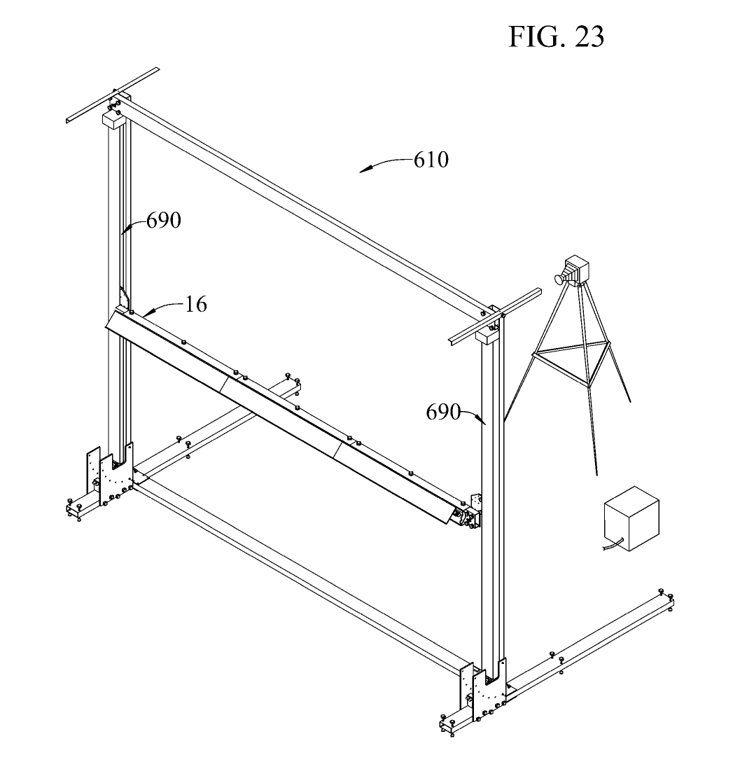

In an alternate embodiment shown in FIG. 20-22, the system 510 the light bar 516 includes a pair of light bar segments constructed and operative as described above, but that are pivotally mounted at the ends as indicated at 512 of the center light bar segment, together with either a manual pivoting and locking arrangement as shown, or a motorized or otherwise power-controlled pivotal positioning arrangement (operative by the system controls or operator input thereto). The pivotable light bar wings provide additional illumination that is particularly useful for 3-D subjects and enable further photographic expression.

From the foregoing, it will be apparent that the present invention brings to the art a new and unique system, method and apparatus for illuminating a photographic subject. Certain alternate embodiment illumination systems, methods and apparatus are shown in the drawings and discussed herein, and additional embodiments and aspects of implementing the system, methods and apparatus are discussed herein. Those skilled in the art will understand that still additional alternate embodiments may be provided that will fall within the scope of the invention, such as, for example, an illumination system provided with a light bar that is curved to produce an even the band of light for progressively illuminating a curved surface of a subject.

1. A method for illuminating a photographic subject comprising:
a) establishing a band of light projecting across one direction of the subject;
b) powering the band of light at a controlled speed through a second direction to progressively illuminate the subject; and
c) making a photographic exposure of the subject with a camera while progressively illuminating the subject with said band of light.

2. The method as defined in claim 1 in which the band of light is polarized light.

3. The method as defined in claim 1 in which the camera is a digital camera, and the method further comprises synchronizing the powering of the band of light and the operation of the camera.

4. A method for illuminating a photographic subject comprising
a) positioning a camera for viewing and photographing the subject in a planar field of view,
b) positioning an illumination system between the camera and the subject, the illumination system being characterized as not in supporting contact for the subject, the illumination system comprising
i) a frame,
ii) a powered linear drive unit carried on the frame,
iii) a linear light source connected to the linear drive unit for powered linear movement;
a) the linear light source being configured to produce a band of linear illumination of substantially constant intensity along a first direction,
b) the linear drive unit being operative to move the linear light source along a second direction to progressively illuminate the planar field of view of the camera; and
iv) digital system controls for controlling movement of the linear drive unit to achieve controlled linear movement of the linear light source through said plane; and
c) moving the linear light source to progressively illuminate the planar field of view and subject therein while making a photographic capture of the subject.

5. The method as defined in claim 4 in which the linear light source produces a linear band of polarized light to progressively illuminate the subject.

6. The method as defined in claim 4 in which the band of light is of substantially constant intensity along the length thereof.

7. The method as defined in claim 4 in which the camera is a digital camera and the system controls are integrated with the camera controls for synchronized operation of the illumination system and the camera.

8. A system for illuminating a photographic subject comprising:
a) a frame;
b) a powered linear drive unit carried on the frame;
c) a linear light source connected to the linear drive unit for powered linear movement;
i) the linear light source being configured to produce a band of linear illumination of substantially constant intensity along a first direction,
ii) the linear drive unit being operative to move the linear light source along a second direction to progressively illuminate a planar field of view; and
d) system controls for controlling the linear drive unit to achieve controlled progressively illumination of the planar field of view; the system controls comprising
i) an input module providing a signal indicative of the desired movement of the linear light source and desired illumination characteristics as the linear light source progressively illuminates said planar field of view, and
ii) an automated control module operatively connected to the input module and operative to control the linear drive unit and linear light source;
e) the linear drive unit being located outside the progressively illuminated planar field of view.

9. The system as defined in claim 8 in which the automated control module is a digital control module.

10. The system as defined in claim 9 in which the system controls are synchronized with software drivers of a digital camera.

11. The system as defined in claim 8 characterized as not including a table to support a photographic subject.

12. The system as defined in claim 8 in which the frame is free-standing to support the system on a horizontal surface.

13. A system for illuminating a photographic subject comprising:
a) a frame with a free-standing base and a mount that is pivotally connected to the base for incrementally swinging between horizontal and vertical positions;
b) a powered linear drive unit carried on the frame;
c) a linear illumination source carried on the mount for incremental swinging therewith,
i) the linear light source being connected to the linear drive unit for powered linear movement to produce a band of linear illumination along a first direction,
ii) the linear drive unit being operative to move the linear light source along a second direction to progressively illuminate a planar field of view; and
d) d) system controls operatively connected to the linear drive unit to achieve controlled progressively illumination of the planar field of view through controlled movement of the linear light source.

14. The system as defined in claim 13 in which the mount is removably connected to the base.
